(19) United States
(12) Patent Application Publication
(10) Pub. No.: US 2021/0090173 A1
(43) Pub. Date: Mar. 25, 2021

(54) FINANCIAL DEFENSIVE CONDITION ALERT, NOTIFICATION, AND COMMUNICATION SYSTEM AND METHOD

(71) Applicant: Gerald C. Steffes, Overland Park, KS (US)

(72) Inventor: Gerald C. Steffes, Overland Park, KS (US)

(21) Appl. No.: 17/026,827

(22) Filed: Sep. 21, 2020

Related U.S. Application Data
(60) Provisional application No. 62/902,492, filed on Sep. 19, 2019.

(51) Int. Cl. G06Q 40/06; G06Q 30/02

(52) U.S. Cl. CPC G06Q 40/06; G06Q 30/0201

(57) ABSTRACT

A financial defensive condition alert, notification, and communication system and method for promptly and accurately identifying turning points in the economic business cycle; quickly transmitting notification messages to a remote computing device regarding changed economic conditions in real time; and providing a user interface having economic information, asset allocation recommendations, and communication capabilities. The system includes a central computing device, a communications network, a database configured to continually receive and store updated economic data, a series of economic indicator triggers, an alert level system, a remote computing device, and a user interface. The system may further integrate a financial account custodian and/or a financial advisor remote computing device. An embodiment utilizes five different indicator signals to indicate and/or respond to turning points in the business cycle and recession-like economic conditions.

### CROSS-REFERENCE TO RELATED APPLICATION

This application claims priority in U.S. Provisional Patent Application No. 62/902,492, filed Sep. 19, 2019, which is incorporated herein by reference.

### BACKGROUND OF THE INVENTION

### 1. Field of the Invention

The present invention relates generally to a remote computing device alert and communications system. More specifically, the invention relates to a proprietary system and method for quickly and efficiently identifying macroeconomic and business cycle trends and alerting users of changing conditions in real time to accommodate optimized investment portfolio dynamic asset allocation with the goal of increased long-term performance and reduced investment risk relative to a passive buy and hold strategic asset allocation strategy.

### 2. Description of the Related Art

The United States economy continually fluctuates up and down, depending upon many different factors. This process of repeated long-term economic expansion and contraction is commonly referred to as the business cycle. The ultimate goal of investing is to optimize long-term portfolio performance and increase value as much as possible, but changes in the business cycle can make decisions for how to allocate assets very difficult. Investors generally want to “buy low” and “sell high.” However, since the equity markets generally trend upward over the long term, it is important not to overreact to every drop in the equity markets. The volatility of the equity markets often causes investors to make imprudent, emotional investment decisions in hopes of maximizing their returns and avoiding drops in the equity markets. FIG. 22 illustrates three different points in time of historical S&P 500 Index data showing the difficulty in determining whether a downturn in the equity markets is the beginning of a business cycle recession or a mere equity market correction or isolated event.

As most investors have learned, it is very difficult to keep up with everchanging economic events that impact the investment markets and to try to time the stock market, yet when investors experience a significant decline in their portfolio values, there is a tendency to eventually reduce equity allocations in an attempt to avoid further losses. In essence, many investors sell low after significant stock market declines have already occurred. Then, many investors will reinvest back into the stock market once the stock market has significantly recovered. In other words, many investors buy high after the market has gone back up, missing out on significant economic gains.

Asset allocation is the implementation of an investment strategy that attempts to balance risk versus reward by adjusting the percentage of each asset in an investment portfolio. Commonly used asset allocation techniques tend to follow one of three primary strategies: strategic asset allocation, tactical asset allocation, or dynamic asset allocation.

Strategic asset allocation is a more traditional approach that utilizes the tenants of Modern Portfolio Theory in a passive investment style. With strategic asset allocation, an investor establishes their investment portfolio's strategic allocation and primarily follows a buy and hold strategy. The goal of strategic asset allocation is to create a portfolio based on the investment goals, risk tolerance, and time horizon of the investor. Changes in the investment portfolio's allocation among each asset class are usually only made when the portfolio becomes “unbalanced” due to fluctuations in the market or when the investor's risk/reward profile changes.

Tactical asset allocation is a more active investment strategy that continually adjusts a portfolio's asset allocation among various asset classes. The goal of a tactical asset allocation strategy is to improve upon the risk-adjusted returns produced by strategic asset allocation. Tactical asset allocation attempts to add value by overweighting asset classes that are expected to overperform on a relative basis in the near term and underweighting asset classes that are expected to underperform in the near term. Tactical asset allocation typically relies on financial and economic variables or signals used to assign relative short-term asset class weightings. Tactical asset allocation generally focuses on asset classes of stocks, bonds, and cash, but can also include asset classes such as real estate, currencies, commodities, and o e alternative investments.

Dynamic asset allocation, includes principles from both strategic and tactical asset allocation strategies. The goal of macro-based dynamic asset allocation is to create a portfolio based on an investor's goals, risk tolerance, time horizon, and macroeconomic trends in the economy and/or stock market. Long-term gains and protecting against substantial losses are the primary concerns of a dynamic asset allocation strategy. Dynamic asset allocation is less concerned with maximizing short-term returns of individual investments and the associated risk than tactical asset allocation but includes more buying and selling and asset reallocation than a buy and hold strategic asset allocation strategy based on overall market trends.

The primary goal of studying macro-trends in the economy or stock market is to identify turning points in the business cycle. Economic growth tends to be measured by the upward and downward fluctuation of gross domestic product along its natural growth rate over time. Business cycles are typically identified as having four phases: expansion, peak, contraction, and trough. Understanding where the economy is in the business cycle can help investors make informed investment decisions and make changes to their asset allocation.

Investment assets have two primary types of risk: systematic and unsystematic. Systematic risk, also known as market risk or macroeconomic risk, is vulnerability for unanticipated events that affect almost all investments and asset classes, at least to some degree, because of economy-wide effects. Unsystematic risk, also called unique risk or microeconomic risk, is vulnerability for unanticipated events that affect individual investments or individual asset classes. Highly diversified portfolios tend to have very little unsystematic risk. Thus, use of broad market equity funds, such as the S&P 500 Index or total market equity index funds, diversify away most unsystematic risk.

Considering that unsystematic risk can be mostly eliminated by diversification, the “systematic risk principle” states that the reward for bearing risk depends on the level of systematic risk. In investment risk calculations, the level of systematic risk in a particular investment or asset class, relative to an average of similar investments such as a broad market index fund, is given by the Beta coefficient of that investment. Alpha is a measure of performance on a risk-adjusted basis and is the return on an investment that is not the result of the general movement in the greater market it is benchmarked against. A widely recognized model is the “Optimal Risk Portfolio in the Single-Index Model” formula:

E(Rₚ)=E(Rₘ)Bₚ+aₚ

E(Rₚ)=Expected return of the portfolio

E(Rₘ)=Expected return of the market

Bₚ=Beta of the portfolio

aₚ=Alpha of the portfolio

The Alpha for highly diversified index funds tends to be at or very close to zero. So, if the expected return of the equity markets during a recession is negative, then reducing the Beta of the investment portfolio during a recession results in the expected return of the investment portfolio incurring reduced losses relative to the expected losses of the equity markets.

Over time, some of the most dramatic declines in portfolio values have been experienced during economic recessions. So, the ability to accurately and efficiently identify a recession and to reallocate assets accordingly is very important for minimizing portfolio losses and maximizing portfolio profitability. As a general rule, a recession is a significant decline in economic activity spread across the economy, lasting more than a few months, normally visible in real gross domestic product (GDP), real income, employment, industrial production, and wholesale retail sales. In the early stages of a recession, shifting investment assets from equity investments into more stable fixed income investments, such as money market funds or short-term bonds, results in a lower Beta for the overall investment portfolio.

However, recessions are typically determined retroactively by the National Bureau of Economic Research (NBER) rather than in real time. So, by the time a recession has been officially determined by the NBER, significant loss in value of investment portfolios may have already occurred.

There are many known macroeconomic and business cycle trends that are analyzed by financial professionals when attempting to forecast what investment markets will do. While some of these trends can be indicators of a coming or ongoing recession, they each have their issues when looked at individually. For instance, an individual forecaster of economic recession may produce false signals over time in addition to eventually signaling an actual recession.

One known potential forecaster of economic recessions is an inverted Treasury bonds yield curve. Typically, 90-day, one-year, and two-year Treasury bond yields are lower than ten-year Treasury bond yields. When 90-day, one-year, and/or two-year Treasury bond yields become greater than ten-year Treasury bond yields, it is an inversion of the various maturities of yield curve. FIG. 21 shows a series of line graphs illustrating historical inversions in Treasury bond interest rate yields preceding recessions. As a rule of thumb, an inverted yield curve may indicate a recession within the next 12-18 months. However, this indicator, on its own, can produce false signals. Additionally, government manipulation of Treasury bond yields could potentially impact this pattern.

The Leading Economic Index is produced monthly by the Conference Board, a non-governmental, non-profit business membership and research group organization. The Leading Economic Index takes into account ten economic variables which have historically turned downward before a recession and upward before an expansion. The ten economic variables are average weekly manufacturing hours, average weekly initial claims for unemployment insurance, manufacturers' new orders for consumer goods, ISM new orders index, manufacturers' new nondefense capital goods orders, building permits for new private housing, S&P 500 stock index, Leading Credit Index, interest rate yield curve using the federal funds rate and ten-year Treasury bonds, and consumer sentiment. These indicators tend to shift ahead of business cycle turning points, so the Leading Economic Index is intended to be a leading indicator of a recession. However, the Leading Economic Index can also produce false signals. Another challenge with the Leading Economic Index data is that revisions are made to the data after its initial release. Therefore, the Leading Economic Index data viewed initially may be different than the historical data used to develop trading systems.

Employment trends can also be an indicator of a recession. The Bureau of Labor Statistics produces weekly and monthly data on employment and unemployment in the United States. As a general rule, when seasonally adjusted employment rates are decreasing relative to the previous year's seasonally adjusted employment rates, the risk of recession significantly increases. However, using employment information alone as an economic indicator can produce false signals, and other factors can influence employment trends. Employment statistics are also revised after initial release so the initial data may be different than the historical data used to develop trading systems.

The Chicago Federal Reserve Bank's National Activity Index (CFNAI) is a monthly index that is designed to gauge overall national economic activity. The CFNAI is a weighted average composite of 85 monthly indicators and designed to have an average value of zero. The 85 indicators are drawn from four broad categories of economic data: production and income; employment, unemployment, and hours; personal consumption and housing; and sales, orders, and inventories. A CFNAI value of −0.7 or lower is intended to indicate a strong potential for recession. However, CFNAI data is also subject to revisions after its initial release, and it could produce false signals.

Consumer spending trends can be an indicator of a recession. Consumer spending, also known as personal consumption expenditures, is the value of goods and services purchased by or on behalf of U.S. residents and makes up approximately two-thirds of Gross Domestic Product (GDP). Changes in consumer spending impacts industrial production, capital spending, and corporate profits. A decrease in consumer spending using moving averages over the previous three to twenty-four months can indicate recession-like conditions. However, consumer spending trend data can produce false signals.

The Coincident Economic Index is another economic indicator produced by the Conference Board. The Coincident Economic Index is based on four key variables that attempt to measure current economic activity in the business cycle. The four variables taken into account are employees on non-agricultural payrolls, personal income less transfer payments (e.g., Social Security, welfare), industrial production, and manufacturing and trade sales. These indicators are intended to define the business cycle in real time. However, the Coincident Economic Index also can produce false signals, and the Coincident Economic Index is revised after initial release in the same manner as the Leading Economic Index.

In addition to inversions of the Treasury bonds yield curve, the Leading Economic Index, employment trends, the CFNAI, consumer spending trends, and the Coincident Economic Index, many different economic data sets and indexes are used by economists and financial professionals in attempts to predict turning points in the business cycle, recessions, and other market trends.

Investors desire to have a quick, efficient, and accurate system for identifying turning points in the business cycle leading to economic recession and economic expansion conditions, while not overreacting to every fluctuation in the equity markets. Furthermore, a financial condition alert and notification system similar to the national weather service alerting individuals when hazardous weather is approaching or to the U.S. military's Defense Readiness Condition (DEFCON) system alerting U.S. armed forces when threats to military bases or national security is increasing would be very beneficial to investors.

Similar to how the national weather service uses Doppler radar, radiosonde upper air observations, and other tools looking for weather patterns that have preceded past hazardous weather, investors need an alert and notification system that looks for hazardous economic patterns that have preceded past economic recessions and expansions.

The national weather service has four primary levels of alert used to inform the public. Likewise, investors would benefit from an alert system quickly informing them of economic patterns and whether the investment markets are likely to experience a typical stock market correction, where they should “hold” their equity allocations; likely to experience a recession, where they may benefit from an asset allocation adjustment to reduce their equity allocation; or likely to experience the beginning of economic recovery, where they should increase their equity allocation.

### SUMMARY OF THE INVENTION

The present invention provides a system and method for promptly reacting to economic trends and turning points in the business cycle, accurately analyzing whether economic trends tend to indicate economic recession or economic expansion conditions, and sending notification to a user's remote computing device via a wireless communications network when an economic condition alert level has changed. In an exemplary embodiment, the system further notifies the user of recommended asset allocations and/or prompts a user to contact the user's financial institution(s) and/or financial advisor(s) via an integrated user interface. In further embodiments of the present invention, the system is configured to automatically implement predetermined changes to a user's asset allocation in real time according to a predetermined asset allocation model in response to a change in alert level.

The system includes a central computing device having a processor; a communications network; a database configured to continually receive and store updated economic data; a series of economic indicator triggers; an alert level system; a user remote computing device having a processor and a display; and a user interface. In an exemplary embodiment, the user remote computing device is a smart device and the user interface comprises a mobile application. Alternatively, the remote computing device may be a computer, and the user interface may be accessible on an internet webpage. The system of the present invention may further include an optional user's financial advisor computing device having a processor and optional display.

An aspect of the present invention includes five indicator signals which tend to indicate and/or respond to turning points in the business cycle and recession-like economic conditions. These indicator signals are based upon analysis of five different economic data sets. The data sets are manipulated, smoothed, and/or analyzed, and the indicator signals are triggered when certain predetermined patterns within the data occur. When two or more indicator signals are triggered, pre-recession conditions are determined to exist, the financial defensive condition (FIN-DEFCON) alert level is raised, and the S&P 500 Index and/or other broad market equity indexes are closely monitored. If two or more of the indicator signals are activated and the S&P 500 Index or other broad market equity index trends downward a predetermined amount, the financial defensive condition (FIN-DEFCON) alert level is further raised, and recommendations are established for adjusting allocation of assets into fixed income investments in stages. When the market begins trending upward based on pre-determined patterns, the financial defensive condition (FIN-DEFCON) alert level is lowered and recommendations are established to move assets back into equity investments in stages.

In an aspect of the present invention, if the financial defensive condition (FIN-DEFCON) alert level is changed, the system automatically transmits a notification of the change in alert level to a user's remote computing device via the communications network. In a preferred embodiment, such notifications are opted into and customized by a user via the user interface. Upon opening the user interface, the system provides personalized asset allocation recommendations based on the current FIN-DEFCON alert level, the user's risk tolerance, the user's age, and the user's investing time horizon. The user is further prompted to take action relating to asset allocation in response to the changed alert level. In an exemplary embodiment, the user interface accommodates contacting a user's preferred financial advisor and/or links to a user's financial institution account website. The user's financial advisor may additionally have a computing device integrated into the system for receiving alert level notifications. In further embodiments, the user can opt into automatic asset reallocations in response to a particular change in alert level based on a financial model based on the user's risk tolerance, the user's age, and the user's investing time horizon.

In a preferred embodiment of the present invention, the system is customizable for each user. The user answers questions relating to age, investing time horizon, and risk tolerance, which information is used in combination with continually updated economic data and the current financial defensive condition (FIN-DEFCON) alert level to provide asset allocation recommendations for the user. In settings, the user also opts in for the types of notifications received to the user's remote computing device and provides financial advisor and financial account information, as desired. The user interface further includes pages to provide information on current economic data and recommendations. Additionally, in a preferred embodiment, a mobile application icon for the mobile application updates with changes to the financial defensive condition (FIN-DEFCON) alert level and corresponding color.

The present invention accommodates timely identification, notification to investors, and prompt action based on turning points in the business cycle when the economy is going from the peak phase to the contraction phase of the business cycle and also when the economy is going from the trough phase to the expansion phase of the business cycle. Heretofore, there has not been a financial defensive condition alert system, method, and mobile applications having the features of the present invention.

### BRIEF DESCRIPTION OF THE DRAWINGS

The patent or application file contains at least one drawing executed in color. Copies of this patent or patent application with color drawings will be provided by the Office upon request and payment of the necessary fee.

The drawings constitute a part of this specification and include exemplary embodiments of the present invention illustrating various objects and features thereof.

FIG. 1 is a schematic diagram of a financial defensive condition (FIN-DEFCON) alert, notification, and communication system embodying the present invention.

FIGS. 2a-2d show a flowchart illustrating a system and method of quickly and efficiently identifying turning points in the economic business cycle, monitoring financial defensive condition alert levels, and recommending investment asset allocations to optimize investment portfolio returns and reduce investment portfolio systematic risk embodying an aspect of the present invention.

FIG. 3 shows a flowchart illustrating a system embodying the present invention transmitting a notification of a change in financial defensive condition (FIN-DEFCON) alert level to a user remote computing device in real time and a mobile application prompting an actionable event in response to the changed FIN-DEFCON alert level.

FIG. 4 shows a flowchart illustrating an alternative embodiment of a system of the present invention transmitting a notification of a change in financial defensive condition (FIN-DEFCON) alert level to a user remote computing device in real time and automatically reallocating user's investment assets according to a predetermined financial model in response to the changed FIN-DEFCON alert level.

FIGS. 5-20 show plan views of a mobile application web interface on a remote smart device of a financial defensive condition (FIN-DEFCON) alert, notification, and communication system and method embodying the present invention.

FIG. 21 is a series of graphs showing Treasury bond historical inverted interest rate yield curves preceding past economic recessions.

FIG. 22 shows multiple points in time, using S&P 500 Index data, where it was difficult for investors to determine if an economic market downturn was the beginning of a recession or a mere market correction, emphasizing the need for the present invention.

### DETAILED DESCRIPTION OF THE PREFERRED EMBODIMENTS

### I. Introduction and Environment

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed form.

### II. Preferred Embodiments

The present invention provides a financial defensive condition (FIN-DEFCON) alert, notification, and communication system and method configured for promptly and accurately identifying turning points in the economic business cycle, economic recession-like conditions, and economic expansion-like conditions; quickly transmitting notification messages to a user on a remote computing device regarding changed economic conditions via a communications network; and providing a user interface having economic information, asset allocation recommendations, and communication capabilities in order to efficiently minimize losses without sacrificing long-term portfolio gains.

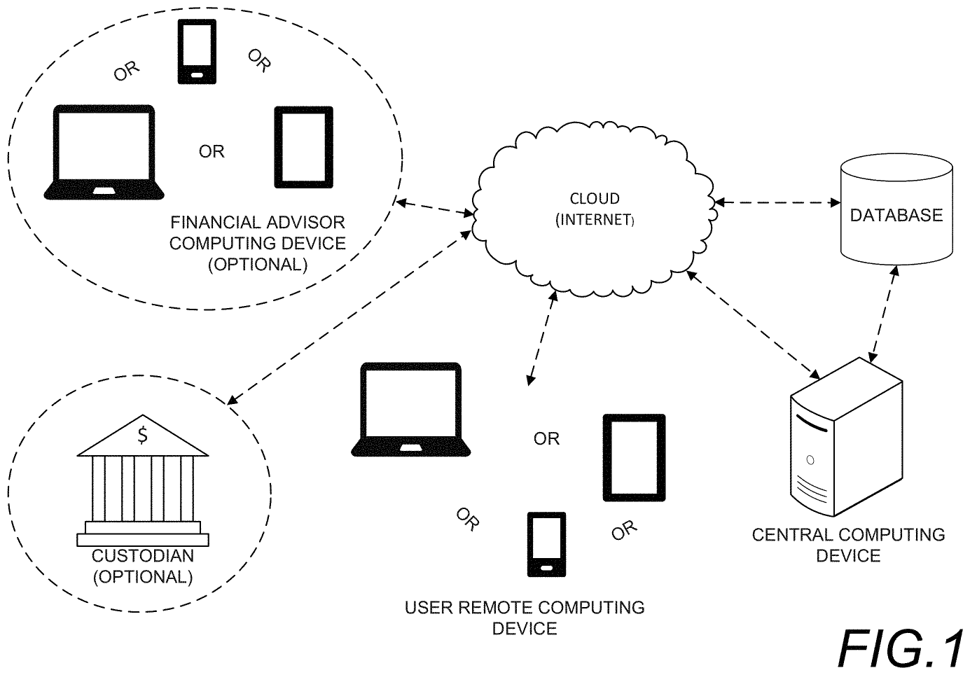

FIG. 1 is a schematic diagram showing components of a financial defensive condition alert, notification, and communication system 2 of the present invention. The system 2 includes a central computing device 4 having a processor and a database 6 having a memory. The database 6 is configured for receiving and storing economic market data. The central computing device 4 and database 6 are each connected to a communications network 26. The communications network 26 may be the internet (cloud) or an intranet, such as but not limited to a wide-area network (WAN) or a local-area network (LAN). The system central computing device 4 and database 6 may or may not also be connected to each other by hardwire. In a preferred embodiment, the system 2 is configured for continually receiving updated economic data from economic data sources via the communications network 26 and storing the economic data in the database 6 memory.

The central computing device 4 processor is programmed to smooth and/or process the economic data. Furthermore, the processor is programmed with economic indicator triggers and a financial defensive condition alert system for analyzing economic data and quickly and accurately identifying turning points in the business cycle and economic recession and economic expansion conditions.

The system 2 further integrates one or more user remote computing devices 8, each having a processor and display and connected to the system 2 via the communications network 26. Such remote computing devices 8 may include, but are not limited to, smart devices, such as smartphones 10, tablets 12, and smart watches, and computers 14, including laptop computers and desktop computers. The present invention further includes a user interface 28 configured for use with the one or more remote computing devices 8. In exemplary embodiments, the user interface 28 is a mobile application or internet webpage accessible from a remote computing device 8 and viewable on the remote computing device display.

In a preferred embodiment, a user opts into receiving notification messages 32 from the financial defensive condition alert, notification, and communication system 2 via the user interface 28 on a remote computing device 8. Preferably, the notification messages 32 are transmitted from the central computing device 4 to the remote computing device(s) 8 via the communications network 26 immediately, in real time, as a financial defensive condition alert level is changed. Optionally, periodic notification messages can also be transmitted to user remote computing devices 8, such as once a month, once a week, or as often as the user desires. Notification messages 32 of the present system may be mobile device push notifications, text messages, email messages, automated telephone voice messages, or any other type of notification message. In an exemplary embodiment, the frequency and type of notification messages are customizable by the user using the user interface 28. Such notifications 32 provide users with immediate notice of changes in the economic market landscape so the users can quickly and efficiently respond and allocate assets accordingly. In an exemplary embodiment, each notification message 32 includes a link to open the user interface 28 on the remote computing device 8.

Preferably, upon opening of the user interface 28 of the present invention for the first time, the system 2 prompts the user to create a username and password; to provide information relating to the user's age and time horizon for drawing income from the investments; and to answer a questionnaire to determine the user's risk tolerance. The system 2 also prompts the user to add in authorized financial advisor information and investment account information, if desired. Moreover, the user can set whether notifications 32 are received on the remote computing device 8 as push notifications, text messages, email messages, and/or automated phone calls. Such information can be changed and customized, via the user interface 28, at any time.

The user interface 28 provides recommended asset allocations based on the current economic alert level and the user's age, time horizon, and risk tolerance and/or a predetermined financial model. The system may further integrate one or more financial advisor remote computing devices 16 each having a processor and connected to the communications network 26, as shown in FIG. 1. Such financial advisor remote computing devices 16 may include, but are not limited to, smart devices, such as smartphones 18, tablets 20, and smart watches, and computers 22, including laptop computers and desktop computers. The system 2 may further include a financial advisor interface viewable on a display on a financial advisor remote computing device 16.

Additional embodiments may integrate the user's financial account custodian 24 into the system 2, as shown in FIG. 1. The user's financial account custodian 24 may be a bank or financial institution which holds the user's financial accounts. In such an embodiment, the user would opt into and/or authorize the system 2 to access the user's financial accounts with the user's custodian 24. The central computing device 4 can be programmed to automatically rebalance the user's asset allocation in real time according to predetermined asset allocations via the communications network 26 in response to changed economic conditions. In an exemplary embodiment, an automated investment manager, also known as a robo-advisor, is integrated which utilizes an algorithm to automatically allocate assets according to a predetermined financial model and current economic conditions. Such robo-advisors may or may not further integrate artificial intelligence in asset allocations.

Preferably, the system 2 prompts the user to enable an actionable event responsive to a change in financial defensive condition alert level. In an exemplary embodiment, the user interface 28 includes one or more direct links to contact the user's financial advisor(s) and/or to go to the user's account website(s). This allows the user to further communicate with financial advisors and/or financial institutions using the present system. In other embodiments, a user interface 28 of the present invention may allow a user to rebalance assets, or request assets to be rebalanced, directly from the system user interface 28. In further embodiments, the user may integrate the system with a financial model and configure the system 2 to automatically reallocate assets in accordance with the integrated financial model in response to a change in financial defensive condition alert level.

In an exemplary embodiment of the present invention, five economic data sets historically indicative of turning points in the business cycle and/or recession-like conditions are obtained from economic data sources and stored in the system database 6 for analysis of current economic conditions by the central computing device 4 processor. In the preferred embodiment, United States Treasury Bonds interest rate yield curve data; the Conference Board's Leading Economic Index data; employment trends data; the Chicago Federal Reserve National Activity Index (CFNAI) data; and consumer spending data are used. Alternatively, the Conference Board's Coincident Economic Index data or other data sets may be used in an indicator trigger, either in addition to or replacing one or more of the aforementioned data sets.

Once the economic data sets are obtained, the data is manipulated to put it in better condition to represent actual economic trends and conditions. One such manipulation is smoothing data using moving or rolling averages. Use of moving averages helps to decrease the effect of post-release revisions to the data and to smooth out the data to better illustrate the overall trends. The data is put into graphic form and closely analyzed for trends and determinative factors. Data may be graphed in a computer program such as Microsoft Excel or any other type of graph-producing program. The analysis includes analysis of the depth, duration, and diffusion of trends. Depth means how deep is the change in the economic indicator data. Duration means how long is the change occurring. Diffusion means how many of the individual factors making up the economic indicator composite are trending in the same direction. An indicator trigger which tends to indicate recession-like conditions is determined for each of the manipulated economic data sets, taking depth, duration, and/or diffusion into account. The data is then analyzed for the presence of the predetermined indicator triggers.

When recession-like conditions are not evident, ten-year Treasury bonds tend to have interest rate yields greater than 90-day, one-year, and two-year Treasury bond interest rate yields. Inversions in the Treasury bond yield curve have historically been a leading indicator of recessions within 12-18 months, with a few false signals. In each instance of a Treasury bond yield curve inversion preceding a recession—August 1957, September 1959, May 1968, March 1973, September 1978, February 1989, April 2000, and June 2006—one-year Treasury bond interest rate yields became greater than ten-year Treasury bond interest rate yields. Treasury bond interest rate yield data is added to the present system 2 and provided to users as it is released, smoothed, and analyzed for inversions in real time or near real time.

Leading Economic Index raw data is obtained from the Conference Board. That data is smoothed using a three-month moving average, lessening the effect of later revisions, and the data is put into graph form. Alternatively, different moving averages could be used. The data is analyzed for depth of decrease or increase, duration of decrease or increase, and diffusion of individual factors decreasing or increasing at the same time. Decreases in the Leading Economic Index, using smoothed data and analyzing depth, duration, and diffusion, are set as a recession-like condition indicator signal or trigger. The Leading Economic Index indicator signal has historically been a good leading indicator of recessions and expansions, with some false signals and one late signal. Leading Economic Index data is added to the system 2 and provided to users as it is released, smoothed, and analyzed for the Leading Economic Index indicator signal in real time or near real time.

The Chicago Federal Reserve National Activity Index (CFNAI) is produced as a weighted average of 85 monthly economic trends, and it is designed to have an average value of zero. Based on the weighted averages, a CFNAI value of −0.7 or lower is intended to indicate a strong potential for recession. Data is obtained from the Chicago Federal Reserve, smoothed with moving averages, and graphed. The CFNAI indicator signal or trigger is set for a value of −0.7 or lower. The CFNAI indicator signal has historically been a good indicator of recessions, with some late signals. CFNAI data is added to the system 2 and provided to users as it is released, smoothed, and analyzed for the CFNAI indicator signal in real time or near real time.

Real personal consumption expenditures raw data is obtained from the Federal Reserve Bank of St. Louis. That data is smoothed using a 3-month moving average, lessening the effect of later revisions, and the data is put into graph form. Alternatively, different moving averages could be used. The data is analyzed for the depth and duration of decreases and increases. Decreases in consumer spending, using smoothed data and analyzing depth and duration, are set as a recession-like condition indicator signal or trigger. The consumer spending indicator signal has generally been a good indicator of recessions, with some false signals. Real personal consumption expenditures data is added to the system 2 and provided to users as it is released, smoothed, and analyzed for the consumer spending indicator signal in real time or near real time.

United States employment and unemployment data is released by the Bureau of Labor Statistics weekly. The employment data is smoothed with a 10-week moving average and converted into a seasonally adjusted employment rate of change relative to the previous year's seasonally adjusted employment rate. Alternatively, different moving averages could be used. Historically, a seasonally adjusted employment rate that is falling from the previous year has been an indicator of an increased risk of recession. An employment rate recession-like indicator signal or trigger is set based on a negative change in the employment rate from the previous year and taking into account a predetermined duration of employment rate decrease, a predetermined speed and duration of unemployment increase, and analysis of moving average crossovers. The employment rate indicator signal has historically been a good indicator of recessions, with some false signals and some late signals. It is noted that these signals have shown to be more accurate since 1981 and may reflect a change in attitude by employers to more quickly reduce their labor force in the early signs of a slowdown in their business. Employment data is added to the system 2 and provided to users as it is released, smoothed, and analyzed for the employment rate indicator signal in real time or near real time.

As described above, each of these economic data sets has historically been an individual indicator of recession-like conditions and a turning point in the business cycle from peak to contraction, dating back to the 1950s and 1960s. However, on their own, each economic indicator has some issues, such as the potential for false signals, post-release data revisions, the potential for government manipulation, etc. Using a combination of multiple recession-like condition indicator signals each from different economic data sets decreases the effect of false signals and reinforces the likelihood of recession-like conditions being present.

In a preferred embodiment, the present invention includes an economic alert level system ranging between one and five, with alert level five indicating no recession conditions are evident and alert level one indicating the highest alert level in which recession conditions exist. However, the alert level designations may be reversed in other embodiments such that alert level one is the lowest alert level and alert level five is the highest alert level. A different number of alert levels may also be used. In further embodiments, more or less than five economic indicator data sets may be used in the present invention. Additionally, in other embodiments, other economic data, some of the aforementioned data sets, or a combination thereof may be utilized.

The alert levels can also be color-coded in the same manner as the U.S. Armed Forces DEFCON system: blue signifies alert level five, green signifies alert level four, yellow signifies alert level three, orange signifies alert level two, and red signifies alert level one. Alternatively, different color-coding or no color-coding can be used. Moreover, in other embodiments, each economic alert level may include a plus or a minus based on whether the economic data is trending toward a higher or lower alert level. Such an alert level plus or minus may be determined by a number of economic factors, as desired, including macroeconomic trends; depth, duration, and diffusion of economic trends; and/or other economic conditions. Additionally, analysis of the acceleration of macroeconomic trends in either direction may be utilized as an additional feature of the present invention.

In a preferred embodiment, when any two or more of the predetermined indicator triggers are triggered, pre-recession conditions are determined to exist and the alert level is moved from five to four. In alternative embodiments, a different number of indicator triggers than two being triggered can be utilized in moving from the lowest alert level to the second lowest alert level. In this embodiment, after moving to alert level four from alert level five, the S&P 500 Index is very closely monitored. Two moving averages are used in monitoring the S&P 500 Index, and crossovers of the long and short moving averages are used to determine whether the market is trending upward or downward. In a preferred embodiment, 25-day and 85-day moving averages are used to analyze trends in the S&P 500 Index data. However, the 25-day and 85-day moving averages are not limiting as alternative moving averages may be used instead. An investor's investment asset allocation is generally not recommended to be changed from the investor's normal, predetermined, non-recession asset allocation at alert level four but rather when the investment markets actually trend downward after two or more economic indicator triggers have been met because the investment markets can increase for a period of time when recession-like conditions exist. Such an occurrence is sometimes referred to as the investment markets having “irrational exuberance.”

While at alert level four—with two or more economic indicator triggers met—if the S&P 500 Index trends downward by a predetermined amount, alert level three is triggered. At alert level three, an investor's asset allocation is recommended to be rebalanced to a predetermined asset allocation for alert level three by reducing equity investments and increasing fixed income investments.

If the smoothed S&P 500 Index continues to trend downward and the smoothed S&P 500 Index drops an additional predetermined amount, the alert level is moved to level two. At alert level two, the investor's asset allocation is recommended to be rebalanced to a predetermined asset allocation for alert level two by further reducing equity investments and increasing fixed income investments.

If the smoothed S&P 500 Index keeps trending down and drops another predetermined amount, alert level one is triggered, meaning recession conditions exist. At alert level one, the investor's asset allocation is recommended to be rebalanced to a predetermined asset allocation for alert level one by further reducing equity investments and increasing fixed income investments to a target asset allocation for when recession conditions exist.

However, if at any time the smoothed S&P 500 Index trends back upward to a predetermined level, taking the moving averages into account, the investor's asset allocation is recommended to be rebalanced toward the investor's long-term target asset allocation. Alternatively, embodiments of the present invention may utilize other economic indicators to determine when the economic markets are trending back upward from the trough phase to expansion of the business cycle. For example, any one or combination of a crossover of the treasury bond yield curve to revert back to normal relative interest rates, the Leading Economic Index trending upward, and the CFNAI trending upward can be utilized to indicate that the business cycle is entering the expansion phase. The recommended reallocation of the investor's dynamic asset allocations is to generally conduct the reallocation in stages, generally three or more. However, alternative strategies for reallocation of asset allocations as the alert level lowers and the market trends upward can be utilized in alternative embodiments of the present invention.

In embodiments of the present invention, different levels of change in the smoothed S&P 500 Index required to move between alert levels may be utilized. Additionally, alternative broad market index funds other than the S&P 500 Index may be used and monitored to indicate systematic economic market trends.

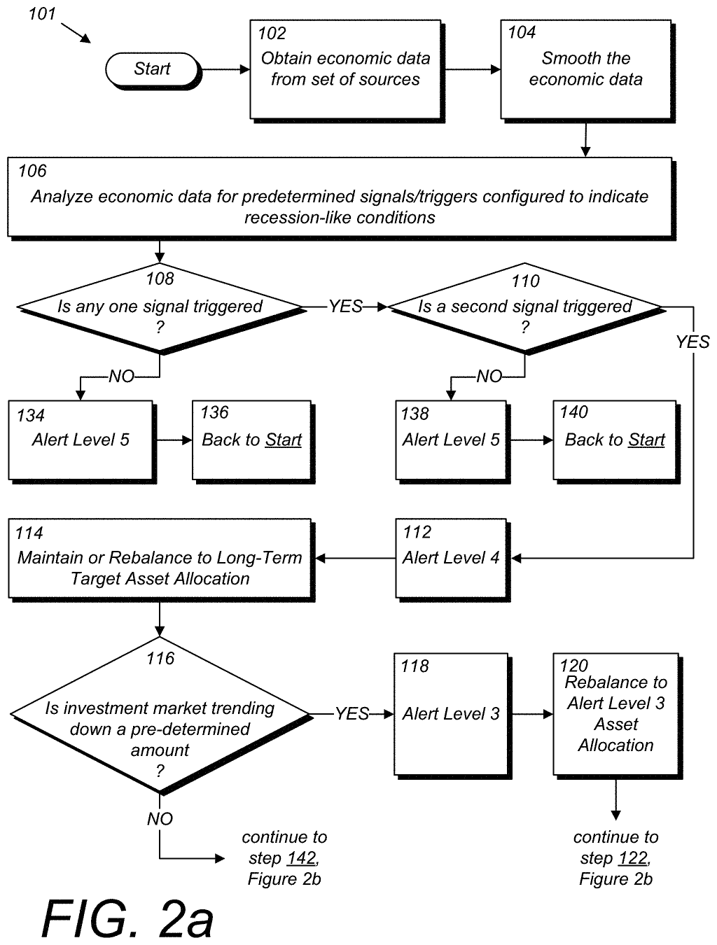

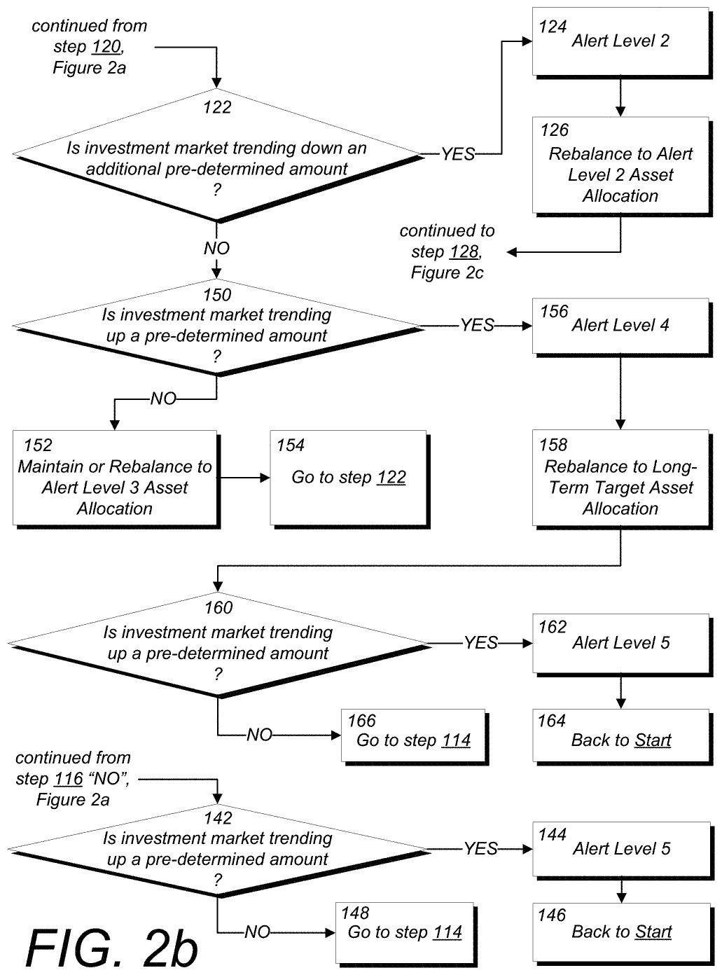

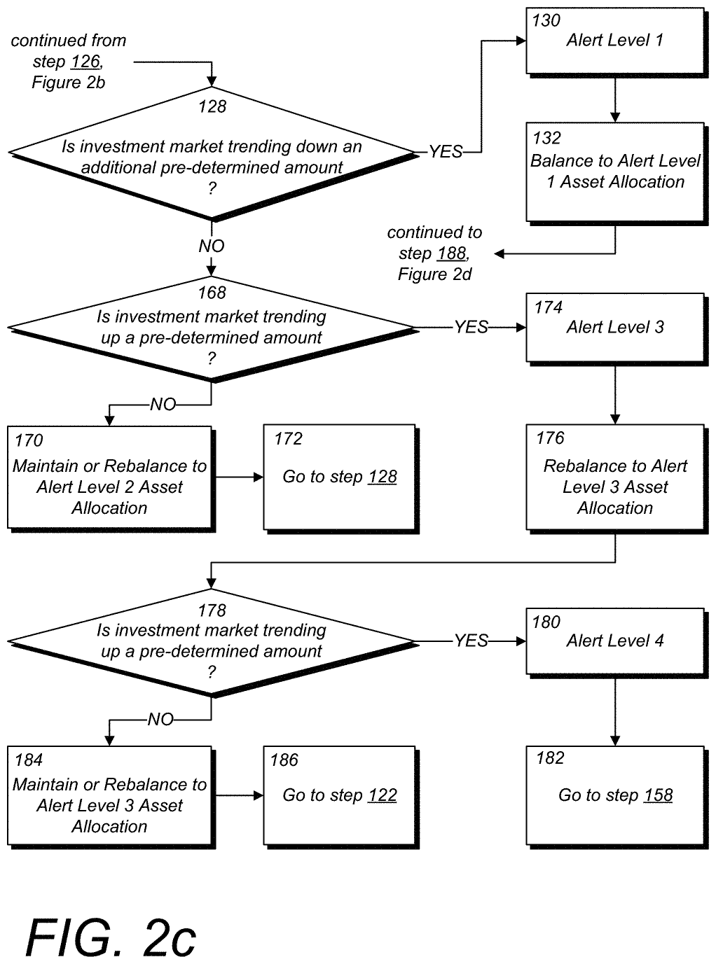

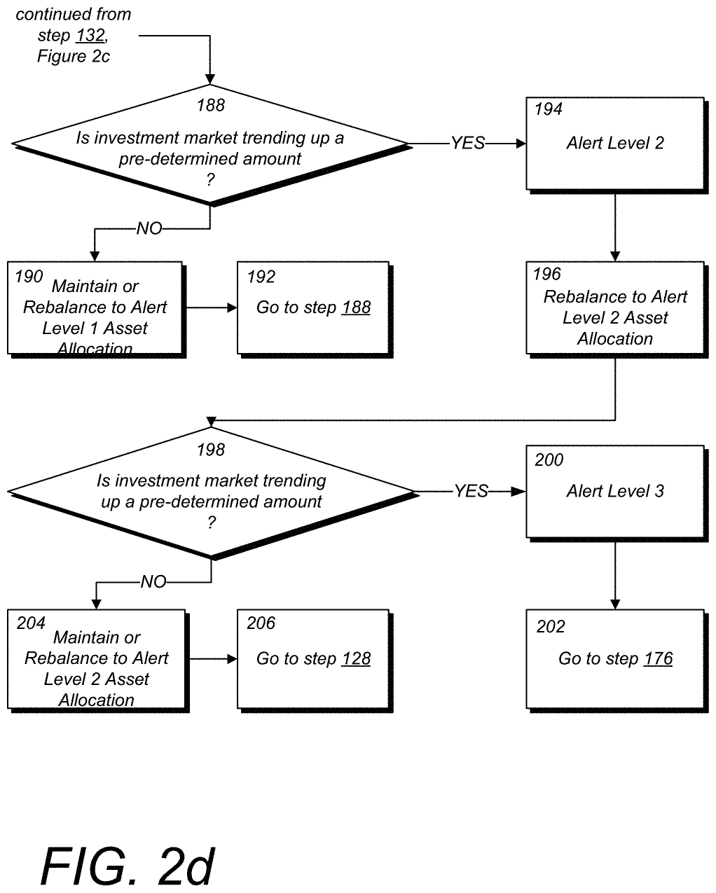

FIGS. 2a-2d show a flowchart illustrating a financial defensive condition alert system and method 101 embodying the present invention. In this embodiment, the financial defensive condition alert system and method 101 includes five alert levels, and assets are recommended to be allocated depending on the current alert level, the trends of the investment markets, and an investor's age, time horizon, and risk tolerance. At step 102, economic data is obtained from a set of multiple economic data sources. In a preferred embodiment, the sets of economic data are Treasury bond interest rate yield data, Leading Economic Index data, employment data, CFNAI data, and consumer spending data. However, alternative economic data sets may be used. At step 104, the economic data is smoothed using moving averages. The moving averages lessen the effects of post-release revisions to the data and help to identify overall trends in the data. At step 106, the smoothed economic data is analyzed for predetermined indicator signals or triggers configured for indicating recession-like conditions. In the preferred embodiment, the indicator signals or triggers are comprised of the Treasury bond interest rate yield inversion indicator signal, the Leading Economic Index indicator signal, the employment rate indicator signal, the CFNAI indicator signal, and the consumer spending indicator signal, each configured as described above. At step 108, it is determined whether any one of the five indicator signals is triggered. If not, the system remains at alert level five at step 134 and the user goes back to the start at step 136. If any signal is triggered at step 108, then it is determined if a second signal is triggered at step 110. If not, the system remains at alert level five at step 138, and the user goes back to the start at step 140. If a second signal is triggered at step 110, alert level four is triggered at step 112.

At alert level four, an investor's asset allocation is recommended to be fully or 100% maintained at the investor's long-term target allocation based on the investor's investment goals, time horizon, and risk tolerance or rebalanced to that target allocation at step 114. From there, it is determined whether the equity markets are trending down a predetermined amount at step 116. In a preferred embodiment, the systematic trends of the equity markets are monitored using smoothed S&P 500 Index data and moving average crossovers. The preferred moving averages are the 25-day and 85-day moving averages of the S&P 500 Index. The predetermined amount at step 116, in the preferred embodiment, is a 25-day moving average and an 85-day moving average crossover trending downward for the S&P 500 Index. Alternatively, a predetermined drop in smoothed S&P 500 Index data may be used. Other predetermined market drop amounts or measurements may also be used. If the equity markets are not trending down a predetermined amount at step 116, it is determined whether the equity markets are trending up a predetermined amount at step 142. In embodiments of the present invention, determination of the equity markets trending upward a predetermined amount may include moving average crossovers, a market index increasing a predetermined percentage, and/or other market measurements, including but not limited to an uninversion of the treasury bond yield curve, the Leading Economic Index trending upward, and the CFNAI trending upward. If the equity markets are not trending up a pre-determined amount at step 142, meaning the equity markets are neither trending down or up predetermined amounts, the user goes back to step 114 from step 148, maintaining an asset allocation at their full long-term target allocation based on the inventor's investment objective, time horizon, and risk tolerance and repeating the process of determining the trends of the equity markets. If the equity markets are trending up a predetermined amount at step 142, the alert level is moved to alert level five at step 144, and the user goes back to the start at step 146.

If the equity markets are trending down the predetermined amount at step 116, alert level three is triggered at step 118. At alert level three, the investor's asset allocation is recommended to be rebalanced to a predetermined asset allocation for alert level three at step 120. Then, it is determined if the equity markets are trending down an additional predetermined amount at step 122. If the equity markets are not trending down the additional predetermined amount at step 122, it is determined whether the equity markets are trending up a predetermined amount at step 150. If the equity markets are not trending up a predetermined amount at step 150, meaning the equity markets are neither trending up or down predetermined amounts, the investor's asset allocation is recommended to be maintained or rebalanced at the predetermined asset allocation for alert level three at step 152 and the user goes back to step 122 from step 154, repeating the process of determining the trends of the equity markets.

If the equity markets are trending up a predetermined amount at step 150, the alert level is moved to alert level four at step 156, and the investor's asset allocation is recommended to be rebalanced or increased to 100% of the long-term target allocation at step 158. From there, it is determined whether the equity markets are trending up an additional predetermined amount at step 160. If the equity markets are not trending up the predetermined amount at step 160, the user circles back to step 114 from step 166, where the investor's asset allocation is recommended to be maintained at 100% of the target allocation and the process of determining trends of the equity markets is repeated. If the equity markets are trending up a predetermined amount at step 160, the alert level is changed to alert level five at step 162, and the user goes back to the start at step 164.

Back at step 122, if the equity markets are trending down an additional predetermined amount, alert level two is triggered at step 124. At alert level two, the investor's asset allocation is recommended to be rebalanced to a predetermined asset allocation for alert level two at step 126. Next, it is determined if the equity markets are trending down an additional predetermined amount at step 128. If the equity markets are not trending down an additional predetermined amount at step 128, it is determined whether the equity markets are trending back up a predetermined amount at step 168. If the equity markets are not trending up a predetermined amount at step 168, the investor's asset allocation is recommended to be maintained or rebalanced at a predetermined asset allocation for alert level two at step 170, and the user goes back to step 128 from step 172, repeating the process of determining the trends of the equity markets.

If the equity markets, at step 168, are trending up a predetermined amount, the alert level is changed to alert level three at step 174, and the investor's asset allocation is recommended to be rebalanced to the predetermined asset allocation for alert level three at step 176. Then, it is determined if the equity markets are trending up an additional predetermined amount at step 178. If the equity markets are trending up the additional predetermined amount at step 178, the alert level is moved to alert level four at step 180, and the user goes to step 158 from step 182, where the investor's asset allocation is recommended to be rebalanced or increased to 100% of the long-term target asset allocation, followed by continued monitoring of the equity markets. At step 178, if the equity markets are not trending up an additional predetermined amount, the investor's asset allocation is recommended to be maintained or rebalanced at the investor's predetermined asset allocation for alert level three at step 184, and the user goes back to step 122, repeating the process of determining the trends of the equity markets.

If the equity markets are trending down the additional predetermined amount at step 128, alert level one is triggered at step 130. At alert level 1, an investor's asset allocation is recommended to be rebalanced to a predetermined asset allocation for alert level 1, which is a target asset allocation for when recession conditions exist, at step 132. At step 188, it is determined if the equity markets are trending back up a predetermined amount. If the equity markets are not trending up a predetermined amount at step 188, the investor's asset allocation is recommended to be maintained at the predetermined asset allocation for alert level 1 at step 190. Then, the user goes back to step 188 from step 192, continuing to monitor whether the equity markets are trending up a predetermined amount.

If the equity markets are trending up the predetermined amount at step 188, the alert level is changed to alert level two at step 194, and the investor's asset allocation is recommended to be rebalanced to the predetermined asset allocation for alert level two at step 196. At step 198, it is determined whether the equity markets are trending up an additional predetermined amount. If the equity markets, at step 198, are not trending up the additional predetermined amount, the investor's asset allocation is recommended to be maintained at the predetermined asset allocation for alert level two at step 204, and the user goes back to step 128 from step 206, repeating the process of determining the trends of the equity markets. If the equity markets, at step 198, are trending up the additional predetermined amount, the alert level is changed to alert level three at step 200, and the user goes to step 176 from step 202, where the investor's asset allocation is recommended to be rebalanced to the predetermined asset allocation for alert level three, followed by continued monitoring of the equity markets.

The flowchart shown in FIGS. 2a-2d illustrates that the financial defensive condition alert system and method 101 creates a continuous loop of equity market analysis and recommended changes in an investor's dynamic asset allocation depending on the trends of the equity markets. Predetermined recession-like indicator signals using economic data are utilized in moving from alert level five to alert level four. Equity market trends dictate the other changes up and down alert levels and their corresponding investor asset allocation changes, until the alert level is moved back to alert level five.

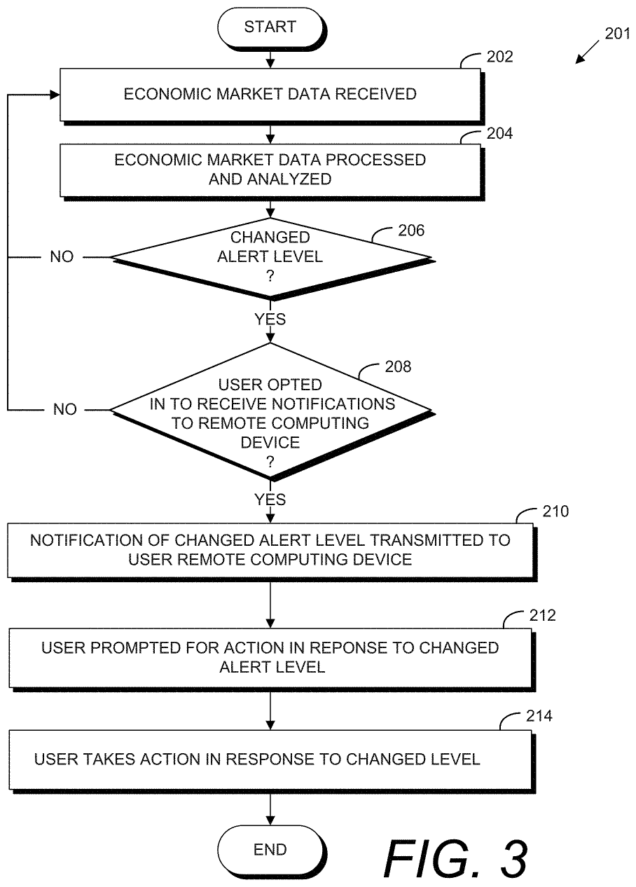

FIG. 3 shows a flow chart illustrating a practical application 201 of the financial defensive condition alert system shown in FIGS. 2a-2d into a financial defensive condition alert, notification, and communication system 2 transmitting notification messages in real time to a user remote computing device 8. At step 202, the system 2 receives economic market data via the communications network 26 and stores the economic market data on the database 6 memory. At step 204, the central computing device 4 then processes the economic data, smoothing the data using moving averages, and analyzes the current economic trends for the current financial defensive condition alert level. Next, it is determined if the financial defensive condition alert level has changed at step 206. If the alert level has not changed, the system continues to receive economic data and processes and analyzes the economic data. If the alert level has changed, the system determines whether one or more users have opted in for receiving system notification messages 32 to a remote computing device 8 at step 208. If at least one user has opted in for notification messages 32 to a remote computing device 8, the system central computing device 4 transmits a notification message 32 in real time to the remote computing device 8 of a changed financial defensive condition alert level at step 210. At step 212, the user is then prompted for an actionable event in response to the changed financial defensive condition alert level. Such an actionable event could include, but is not limited to, contacting the user's preferred financial advisor directly from the user interface 28, linking to a user's financial investment accounts, monitoring current macroeconomic trends, rebalancing asset allocations, and/or any other appropriate response to changed economic conditions. In a preferred embodiment, the user interface 28 displays a recommended asset allocation for the current financial defensive condition alert level based on the user's predetermined investor's goals, risk tolerance, and time horizon and current macroeconomic trends. At step 214, the user then takes action, as desired, in response to the changed alert level.

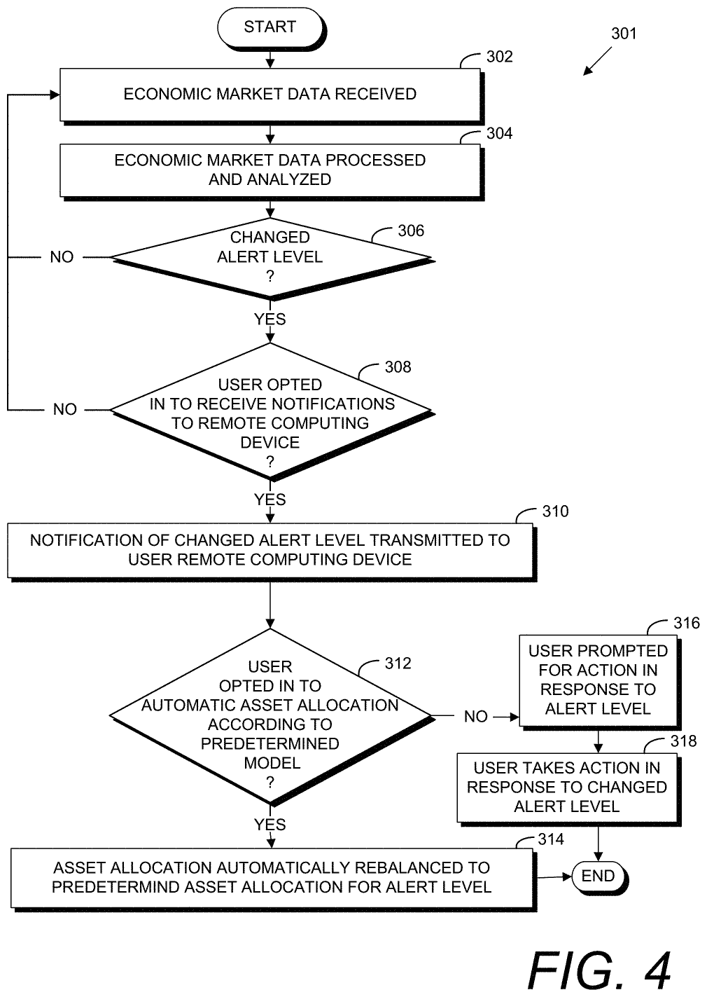

FIG. 4 shows a flow chart illustrating another embodiment of a practical application 301 of the financial defensive condition alert system into a financial defensive condition alert, notification, and communication system 2 which utilizes automatic asset reallocation according to a predetermined financial model in response to a changed alert level. In this embodiment, at step 302, the system 2 receives economic market data via the communications network 26 and stores the data on the database 6 memory. At step 304, the system central computing device 4 processes and analyzes the economic market data and then, at step 306, determines if the financial defensive condition alert level has changed. If the alert level has changed, the system determines if a user has opted in to receive notification messages 32 from the system 2 to a remote computing device 8 at step 308. If so, the central computing device 4 transmits a notification message 32 to the user's remote computing device 8 regarding the changed financial defensive condition alert level via the communications network 26 in real time at step 310. In the embodiment shown in FIG. 4, at step 312, the system 2 then determines whether the user has opted into automatic asset reallocation according to a predetermined financial model based on the current financial defensive condition alert level. Software for automated asset reallocations based on a predetermined financial model, sometimes referred to as “robo-advisors” or “robo-investors,” have become relatively common. In this embodiment, the user can integrate automated asset allocation, as desired, into the present financial defensive condition alert, notification, and communication system 2. If the user has opted in for automated asset allocation according to a predetermined financial model, the system 2 automatically rebalances the user's asset allocations in response to the current financial defensive condition alert level at step 314. If the user has not opted in for automatic asset allocation, the user is prompted for an actionable event in response to the changed financial defensive condition alert level at step 316, and the user takes action in response to the changed alert level, as desired, at step 318.

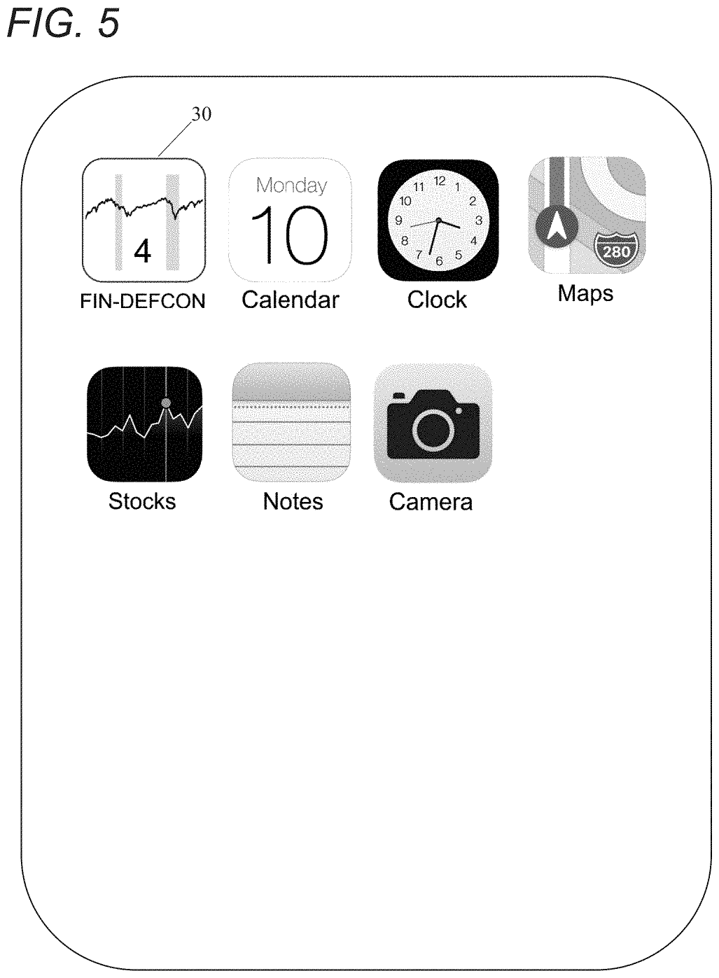

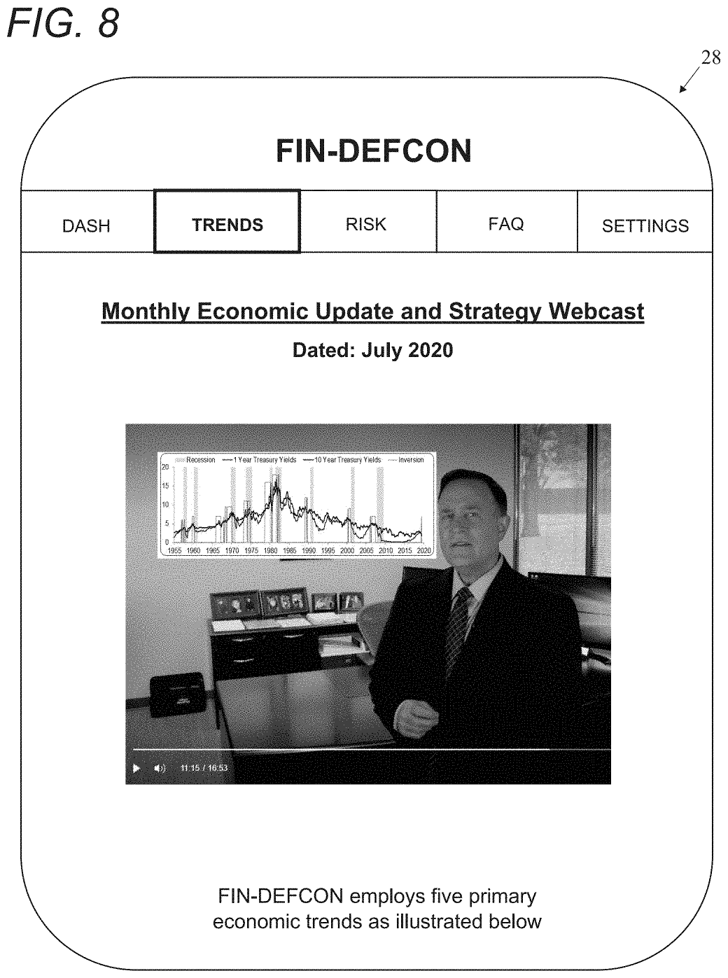

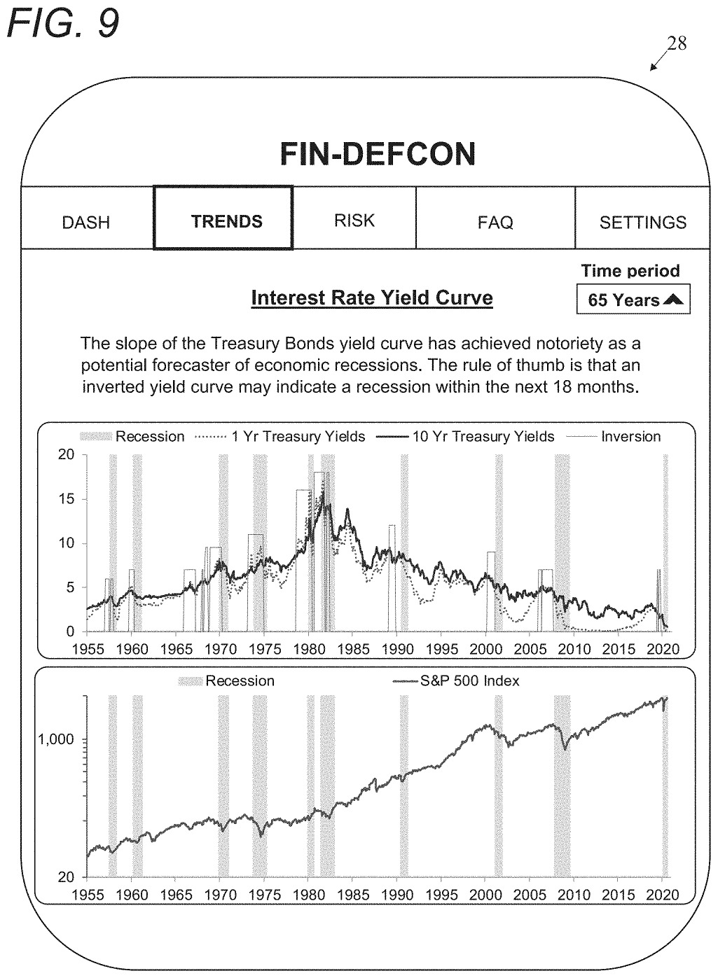

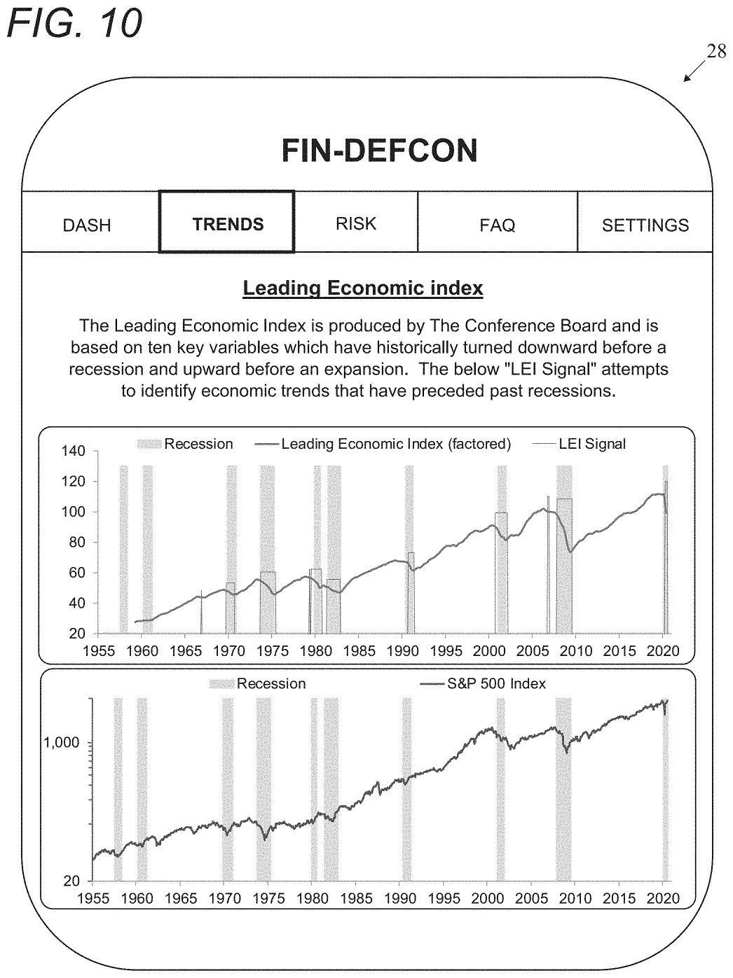

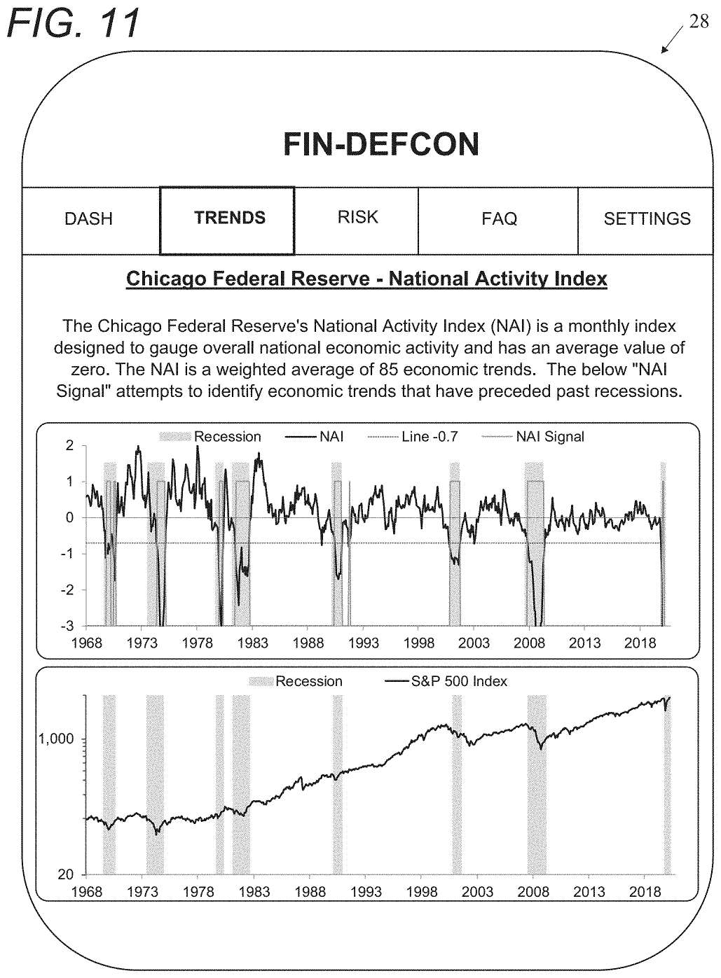

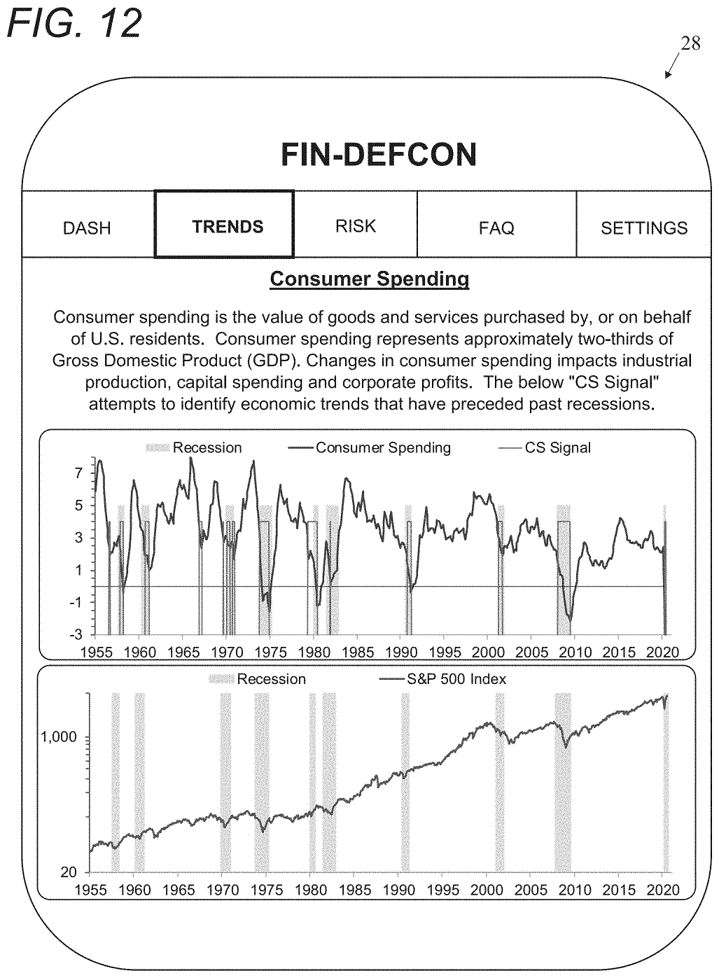

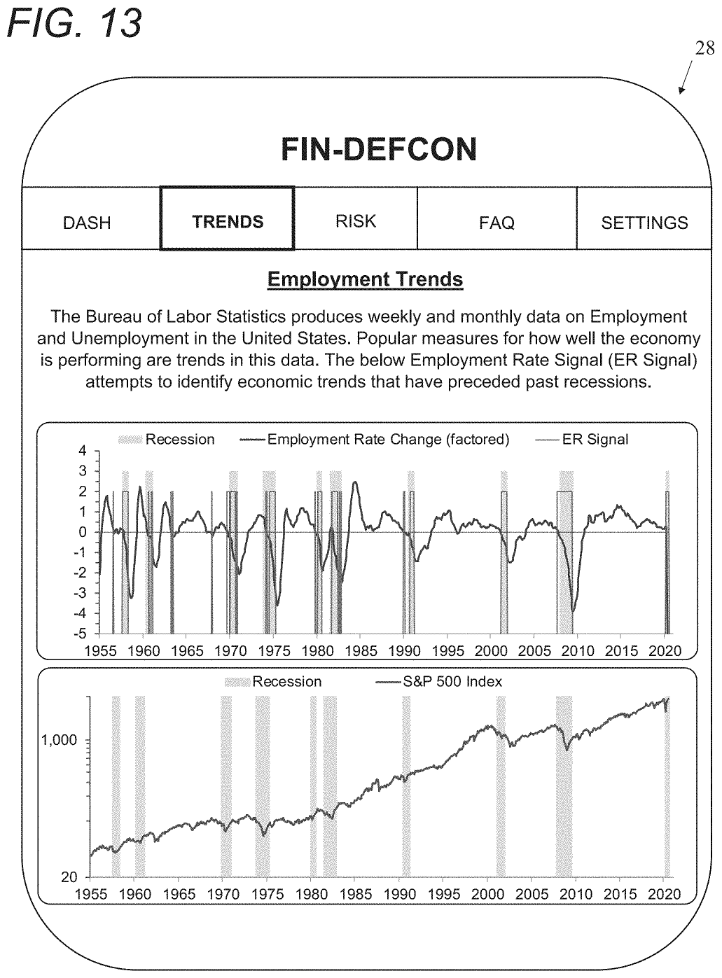

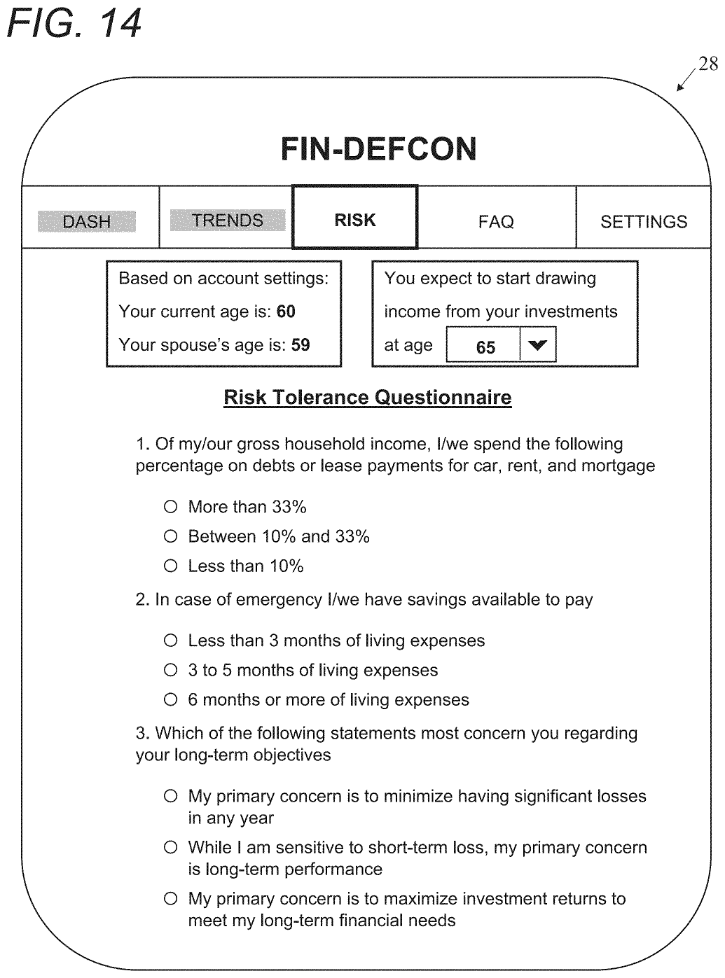

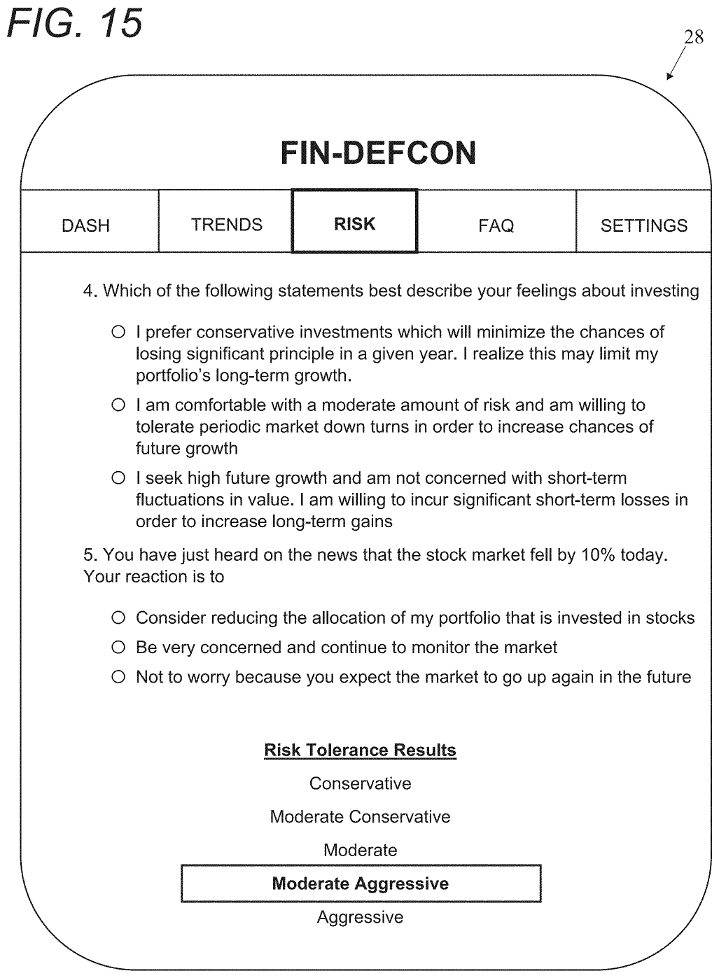

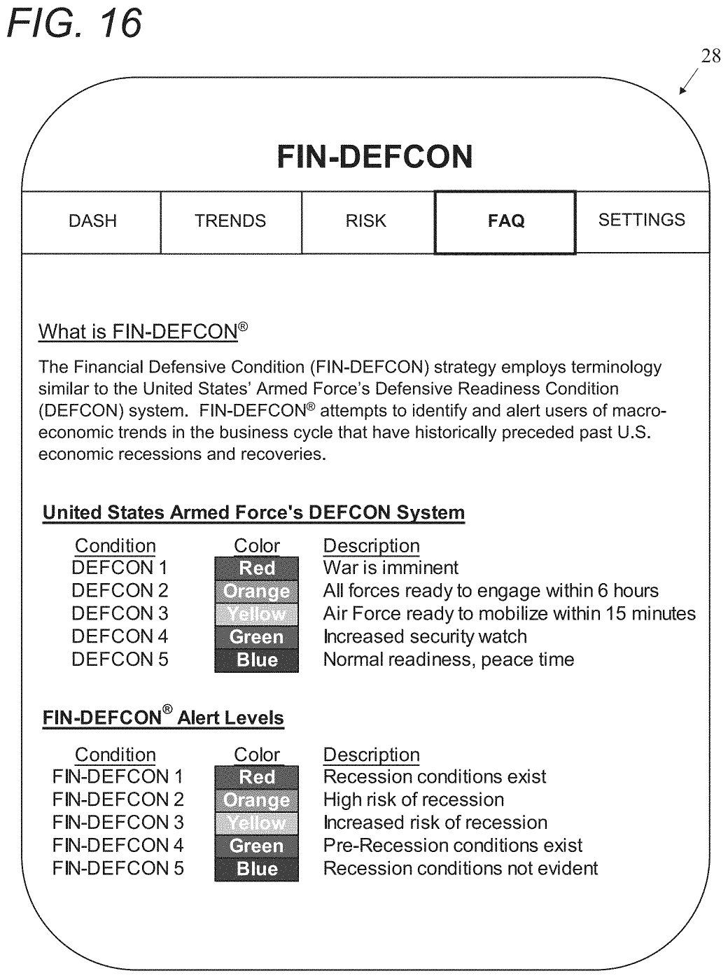

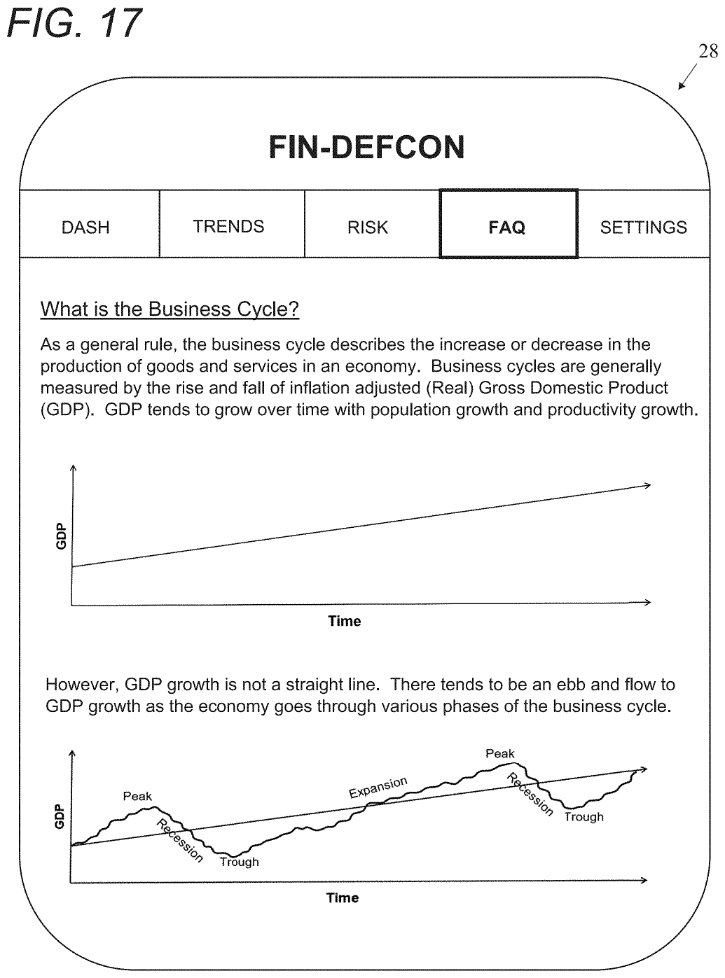

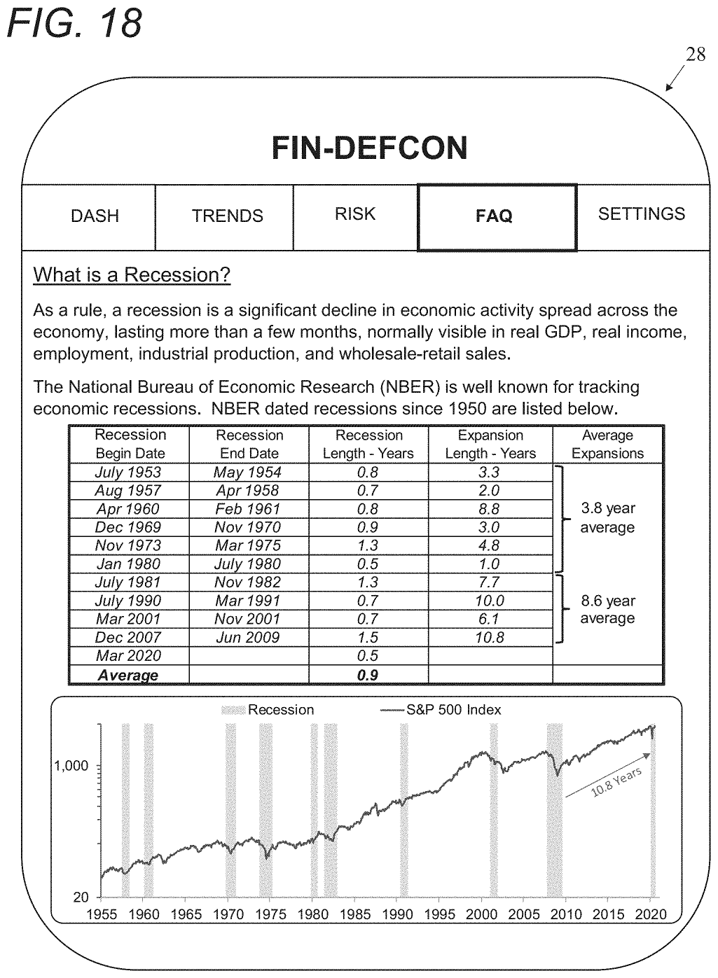

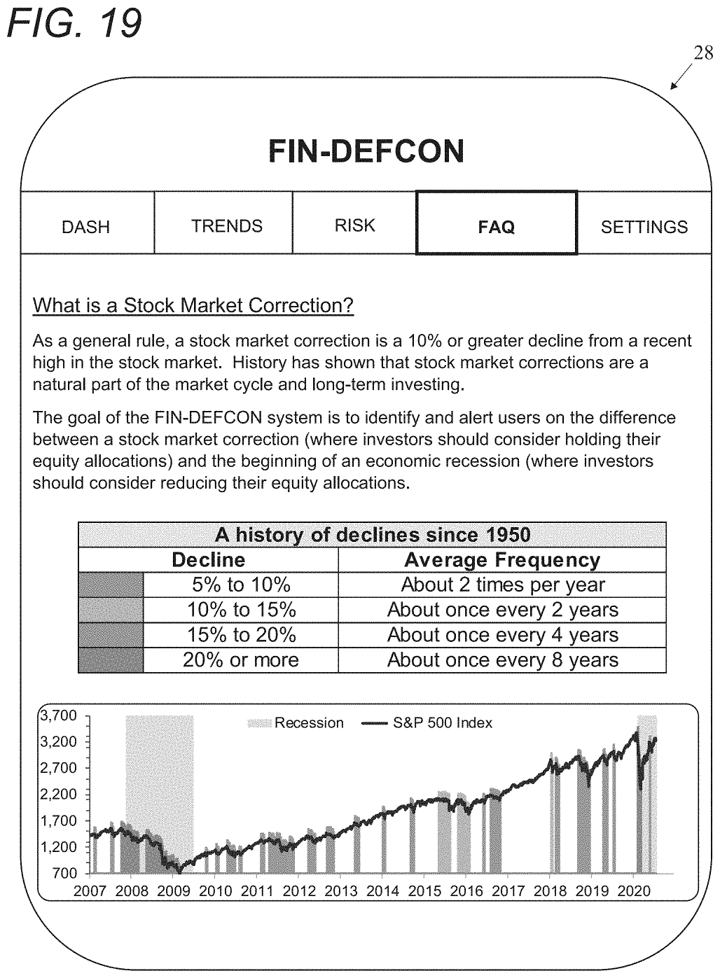

In a preferred embodiment, the user interface 28 of the present invention comprises a mobile application for a smart device. Preferably, the mobile application is compatible with iOS, Android, and any other smart device operating systems, including smartphones, tablets, smart watches, and any other smart devices. FIGS. 5-20 illustrate a mobile application embodying the user interface 28 of the financial defensive condition (FIN-DEFCON) alert, notification, and communication system and method 2. In this embodiment, the user interface 28 includes multiple tabs which allow a user to view a series of different screens. The different tabs may provide information to the user, including but not limited to, the financial defensive condition (FIN-DEFCON) alert level, current market trends, recommended asset allocations, economic informational content, risk tolerance information, and system settings.

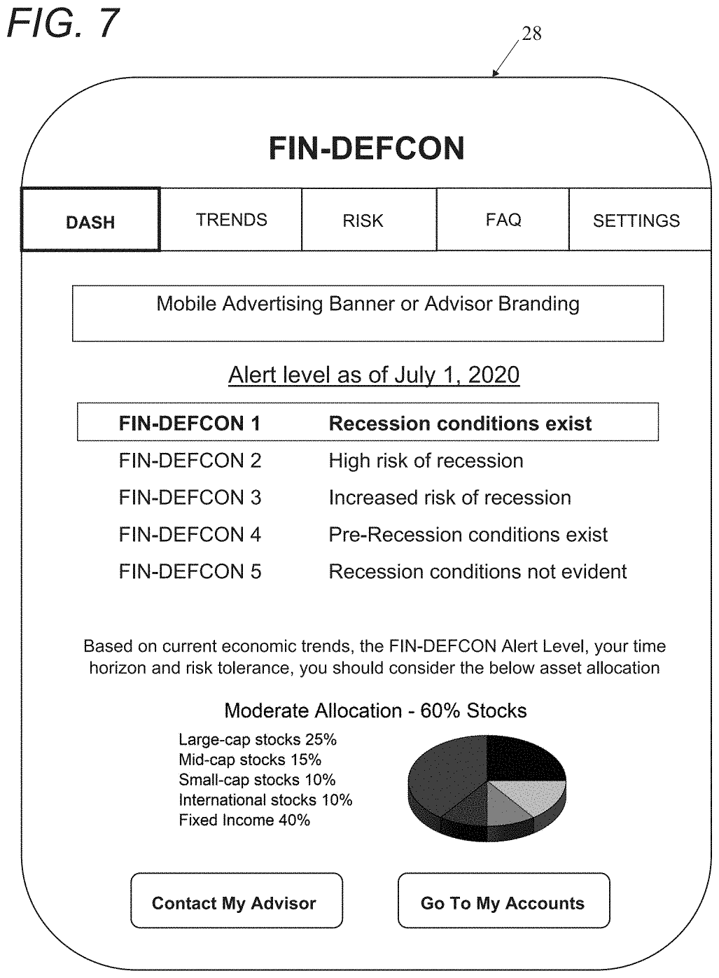

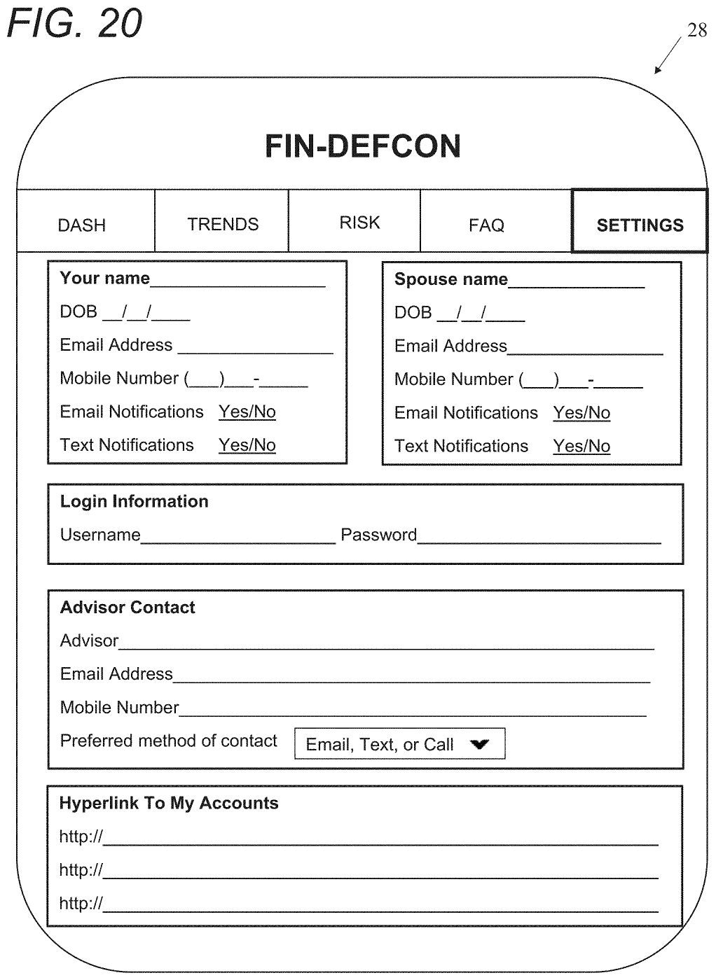

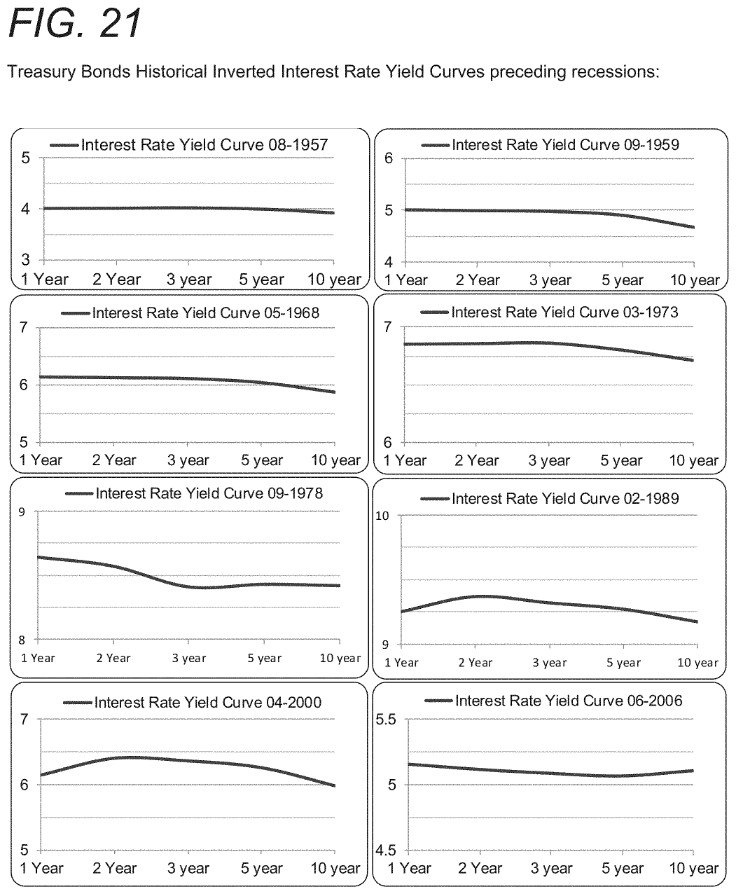

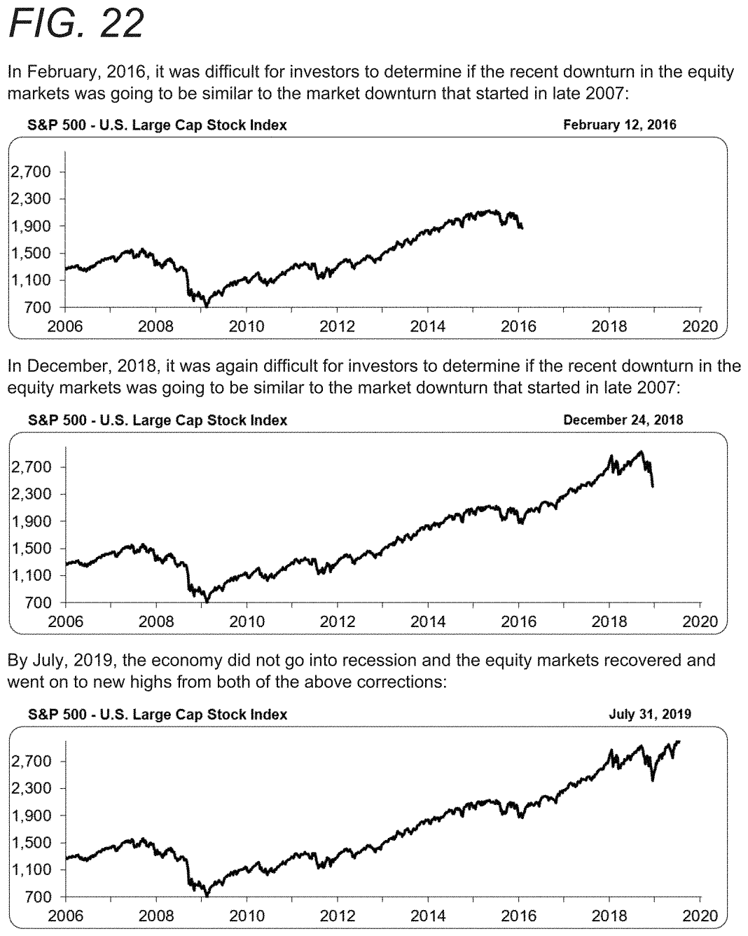

In a preferred embodiment, the user interface 28 includes a link to contact the user's preferred financial advisor directly from the user interface 28, as shown in FIG. 7. The user's preferred financial advisor information and contact preferences can be entered and customized via the user interface 28 settings, as shown in FIG. 20. Preferably, the user interface 28 also includes a link to access the user's account information on the user's financial account custodian's website directly from the user interface 28, as shown in FIG. 7. In this embodiment, the user's account information can be entered via the user interface 28 settings, as shown in FIG. 20.

In an exemplary embodiment, the mobile application icon 30 on a smart device home screen, as shown in FIG. 5, also updates with the current FIN-DEFCON alert level, similar to the way some common clock and calendar mobile application icons update with the time and date, respectively. The icon 30 may update with the particular FIN-DEFCON alert level number and/or the particular color which identifies the current alert level.

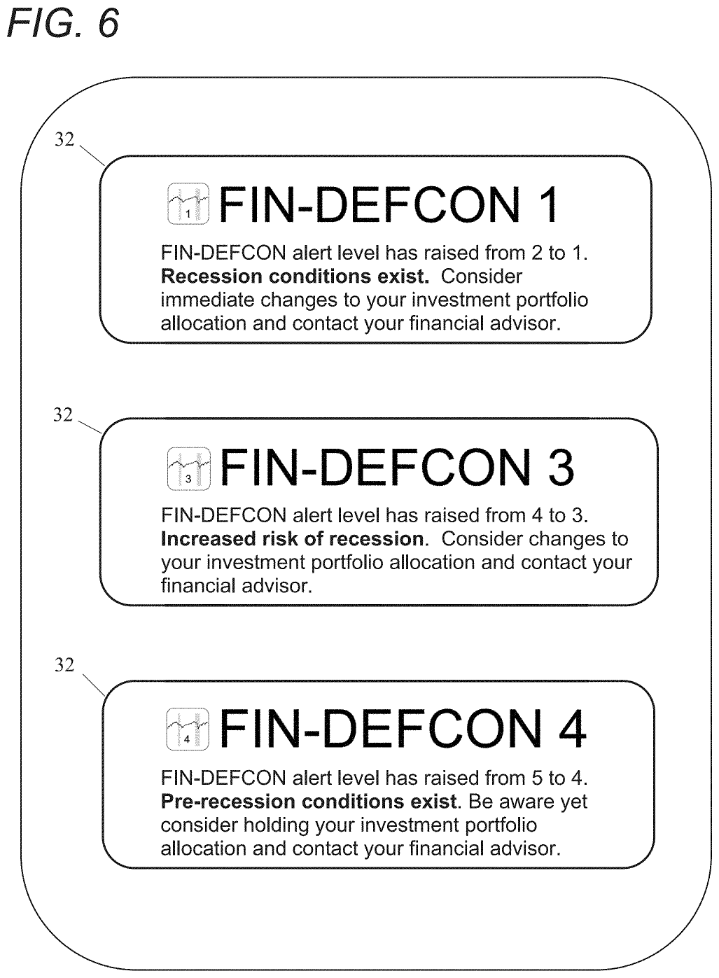

FIG. 6 shows an exemplary embodiment of system notification messages 32 in the form of push notifications received on a remote computing device 8. However, in other embodiments, the system notification messages 32 may be in alternative formats.

Alternatively, or in addition to a mobile application, the user interface 28 may comprise a web interface for use in a computer or mobile device internet browser. Such a web interface would include similar, if not identical, features and pages to a mobile application embodiment.

Embodiments of the present invention may further include a probit model utilizing the economic indicator triggers and market trends to determine the probability of a recession and/or recovery at the current point in time or the probability of a recession and/or recovery within a certain timeframe in the future. Such a probit model could be in addition to or in place of the alert levels. Probit is a term made up of a combination of the words probability and unit. A probit model, sometimes referred to as probit regression, is a way to perform regression analysis for binary outcome variables. Binary outcome variables are dependent variables with two possibilities, such as yes/no or recession/no recession. The probit model estimates the probability a value will fall into one of two possible binary outcomes, such as the economy will experience a recession or the economy will not experience a recession.

Preferably, the financial defensive condition (FIN-DEFCON) alert, notification, and communication system 2 provides notifications 32 to a user's remote computing device 8, whether or not the user interface 28 is currently open, via push notification, text message, email, and/or automated call, immediately upon a change in financial defensive condition (FIN-DEFCON) alert level. Notification messages may also be sent periodically to keep the user updated. After receiving a notification message 32, the user can then open the user interface 28 to view more information, including recommended asset allocation for the user based on the alert level and the user's inputted data. In exemplary embodiments, the user can further contact an authorized financial advisor or financial institution directly from the user interface to quickly re-allocate assets. In further embodiments, the system can be configured for implementing asset allocation changes in real time according to a predetermined asset allocation model in response to a changed FIN-DEFCON alert level.

It is to be understood that the invention can be embodied in various forms and is not to be limited to the examples discussed above. The range of components and configurations which can be utilized in the practice of the present invention is virtually unlimited.

Having thus described the invention, what is claimed as new and desired to be secured by Letters Patent is:

1. A financial defensive condition alert, notification, and communication system comprising:
a central computing device having a processor and connected to a communications network;
a database connected to said communications network and having a memory;
said database configured for receiving economic information including continually updated quantities varying over time via said communications network and storing said economic information on said memory;
a remote computing device having a processor and a display and connected to said communications network;
a user interface accessible on said remote computing device;
five, progressive levels of financial defensive conditions varying over time, wherein financial defensive condition level five comprises the lowest economic recession alert level and financial defensive condition level one comprises the highest economic recession alert level;
said financial defensive conditions being defined by said economic information;
said economic information comprising broad market equity index data and multiple data sets each including a predetermined indicator trigger for detecting a turning point in the business cycle;
said multiple data sets comprising Treasury bond interest rate yield curve data, Leading Economic Index data, employment trends data, Chicago Federal Reserve National Activity Index data, and consumer spending data;
said multiple data set indicator triggers comprising an inversion in Treasury bond interest rate yield curves, a decrease in the Leading Economic Index, a decrease in employment rate from the previous year's employment rate, a Chicago Federal Reserve National Activity Index value of −0.7 or below, and a decrease in the consumer spending;
wherein said central computing device processor is programmed to average said economic information quantities on a rolling basis by dividing the sum of economic information quantities for a predetermined time period by said time period;
wherein said central computing device processor is programmed to reclassify said financial defensive condition levels based on said economic information quantities defined as: if any two or more of said multiple data set indicator triggers are met, reclassify from financial defensive condition level five to financial defensive condition level four, and if classified at any condition level other than financial defensive condition level five, reclassify to the next higher financial defensive condition level if said broad market equity index is trending downward a predetermined downward amount and reclassify to the next lower financial defensive condition level if said broad market equity index is trending upward a predetermined upward amount;
wherein said central computing device is configured for automatically generating and transmitting a notification message to said remote computing device via said communications network in real time when said financial defensive condition level is changed; and
wherein said user interface is configured for displaying said notification message on said remote computing device.

2. The financial defensive condition alert, notification, and communication system according to claim 1, wherein:
said broad market equity index data comprises S&P 500 Index data.

3. The financial defensive condition alert, notification, and communication system according to claim 1, wherein:
said user interface is further configured for accommodating user communication with a preferred financial advisor directly from said user interface.

4. The financial defensive condition alert, notification, and communication system according to claim 1, wherein:
said user interface is further configured for providing a user access to said user's current asset allocations directly from said user interface.

5. The financial defensive condition alert, notification, and communication system according to claim 4, wherein:
said user interface is further configured for accommodating said user rebalancing said user's current asset allocations in response to said financial defensive condition level directly from said user interface.

6. The financial defensive condition alert, notification, and communication system according to claim 1, wherein:
said central computing device is further configured for generating and transmitting periodic system notification messages to said remote computing device via said communications network relating to the current financial defensive condition level;
said user interface is configured for displaying said periodic system notification messages on said remote computing device; and
said periodic system notification messages are customizable via said user interface.

7. The financial defensive condition alert, notification, and communication system according to claim 1, further comprising:
a financial advisor computing device having a processor and a display and connected to said communications network;
a financial advisor interface accessible on said financial advisor computing device;
wherein said financial advisor computing device is configured for receiving said notification message from said central computing device in real time when said financial defensive condition level is changed via said communications network; and
wherein said financial advisor interface is configured for displaying said notification message on said financial advisor computing device.

8. The financial defensive condition alert, notification, and communication system according to claim 7, wherein:
said financial advisor interface is further configured for providing a financial advisor access to a user's current asset allocations directly from said financial advisor interface.

9. The financial defensive condition alert, notification, and communication system according to claim 8, wherein:
said financial advisor interface is further configured for accommodating said financial advisor rebalancing said user's current asset allocations in response to said financial defensive condition level directly from said financial advisor interface.

10. The financial defensive condition alert, notification, and communication system according to claim 1, wherein:
said central computing device is further configured for automatically rebalancing a user's current asset allocation in response to said financial defensive condition level.

11. The financial defensive condition alert, notification, and communication system according to claim 1, wherein:
said financial defensive condition level five indicates that economic recession conditions are not evident, said financial defensive condition level four indicates that pre-recession conditions exist requiring close monitoring of said broad market equity index data, said financial defensive condition level three indicates an increased risk of economic recession, said financial defensive condition level two indicates a high risk of economic recession, and said financial defensive condition level one indicates that economic recession conditions exist.

12. The financial defensive condition alert, notification, and communication system according to claim 1, wherein:
said remote computing device comprises multiple remote computing devices.

13. A financial defensive condition alert, notification, and communication method utilizing a system including a central computing device having a processor and connected to a communications network; a database connected to the communications network, having a memory, and configured for receiving economic information including continually updated quantities varying over time via the communications network and storing the economic information on the memory; a remote computing device having a processor and a display and connected to the communications network; a user interface accessible on the remote computing device; five, progressive levels of financial defensive conditions varying over time, wherein financial defensive condition level five comprises the lowest economic recession alert level and financial defensive condition level one comprises the highest economic recession alert level; the financial defensive conditions being defined by the economic information, the method comprising the steps of:
said database receiving said economic information;
wherein said economic information comprises broad market equity index data and multiple data sets each including a predetermined indicator trigger for detecting a turning point in the business cycle;
wherein said multiple data sets comprise Treasury bond interest rate yield curve data, Leading Economic Index data, employment trends data, Chicago Federal Reserve National Activity Index data, and consumer spending data;
wherein said multiple data set indicator triggers comprise an inversion in Treasury bond interest rate yield curves, a decrease in the Leading Economic Index, a decrease in employment rate from the previous year's employment rate, a Chicago Federal Reserve National Activity Index value of −0.7 or below, and a decrease in the consumer spending;
said database storing said economic information on said memory;
said central computing device processes and analyzes said economic information saved on said memory;
wherein said central computing device is programmed to average said economic information quantities on a rolling basis by dividing the sum of economic information quantities for a predetermined time period by said time period;
wherein said central computing device processor is programmed to reclassify said financial defensive condition levels based on said economic information quantities defined as:
if any two or more of said multiple data set indicator triggers are met, reclassify from financial defensive condition level five to financial defensive condition level four, and if classified at any condition level other than financial defensive condition level five, reclassify to the next higher financial defensive condition level if said broad market equity index is trending downward a predetermined downward amount and reclassify to the next lower financial defensive condition level if said broad market equity index is trending upward a predetermined upward amount;
if said financial defensive condition level has changed, said central computing device automatically generates and transmits a notification message to said remote computing device via said communications network in real time regarding said changed financial defensive condition level; and
said user interface displays said notification message on said remote computing device.

14. The method according to claim 13, further comprising the step of:
a user opts in for receiving notification messages on said remote computing device from said central computing device via said user interface.

15. The method according to claim 13, further comprising the step of:
if said financial defensive condition level has changed, said central computing device automatically rebalances a user's current asset allocation in response to said changed financial defensive condition level.

16. The method according to claim 13, further comprising the steps of:
if said financial defensive condition level has changed, said user interface prompting a user to rebalance said user's current asset allocation in response to said changed financial defensive condition level; and
said user rebalances said user's current asset allocation in response to said changed financial defensive condition level

17. The method according to claim 13, further comprising the steps of:
if said financial defensive condition level has changed, said user interface prompting a user to contact said user's preferred financial advisor in response to said changed financial defensive condition level; and
said user contacts said preferred financial advisor in response to said changed financial defensive condition level.

18. The method according to claim 13, further comprising the steps of:
said central computing device generating and transmitting a periodic system notification message to said remote computing device via said communications network relating to the current financial defensive condition level; and
said user interface displaying said periodic system notification message on said remote computing device.

19. The method according to claim 13, wherein:
said financial defensive condition level five indicates that economic recession conditions are not evident, said financial defensive condition level four indicates that pre-recession conditions exist requiring close monitoring of said broad market equity index data, said financial defensive condition level three indicates an increased risk of economic recession, said financial defensive condition level two indicates a high risk of economic recession, and said financial defensive condition level one indicates that economic recession conditions exist.

20. The method according to claim 13, wherein:
said remote computing device comprises multiple remote computing devices.
